(19) United States
(12) Patent Application Publication
(10) Pub. No.: US 2026/0346192 A1
(43) Pub. Date: Nov. 5, 2026

(54) ATMOSPHERIC WATER GENERATION AT ELEVATION USING CURTAILED RENEWABLE ENERGY

(71) Applicant: Genesis Systems LLC, Tampa, FL (US)

(72) Inventors: David STUCKENBERG, Tampa, FL (US); Shannon STUCKENBERG, Tampa, FL (US); Owen ERICKSON, Tampa, FL (US); Zachary MIXSON, Tampa, FL (US); Jonathan MERHEB, Tampa, FL (US)

(21) Appl. No.: 19/665,936

(22) Filed: May 1, 2026

Related U.S. Application Data
(60) Provisional application No. 63/798,815, filed on May 2, 2025.

(51) Int. Cl. B01D 53/26; C02F 1/28; C02F 1/32; C02F 1/78; C02F 103/02

(52) U.S. Cl. CPC B01D 53/265; B01D 53/263; C02F 1/283; C02F 1/32; C02F 1/78; B01D 2257/80; C02F 2103/02; C02F 2201/009; C02F 2209/006; C02F 2209/008; C02F 2209/42

(57) ABSTRACT

Embodiments described herein relate generally to systems and methods for atmospheric water generation using curtailed renewable energy. Embodiments of the systems and methods described herein may include an atmospheric water generator (AWG) system configured to selectively generate water from ambient air located at a first elevation, a water storage and distribution system configured to store at least a portion of the water generated by the AWG system located at a second elevation equal to or less than the first elevation, and an energy generation system configured to receive at least a portion of the stored water from the water storage and distribution system located at a third elevation less than the first elevation and the second elevation. The energy generation system may be configured to convert a potential energy of the received water into energy.

### CROSS-REFERENCE TO RELATED APPLICATIONS

This application claims priority to and the benefit of U.S. Provisional Application No. 63/798,815, filed May 2, 2025, and entitled “Atmospheric Water Generation Using Curtailed Renewable Energy,” the entire disclosure of which is hereby incorporated by reference herein.

### TECHNICAL FIELD

Embodiments described herein relate generally to systems and methods for atmospheric water generation at elevation and using generated water as a source of potential energy to generate electrical energy on demand.

### BACKGROUND

Renewable energy generation and conventional water supply systems suffer from inefficiencies that often render these systems prohibitively expensive to implement and use, particularly compared against other energy and water supply systems. Conventional systems for renewable energy generation and water supply operate largely in isolation from one another. Renewable energy installations such as wind farms and solar photovoltaic arrays routinely generate electrical energy in excess of what a coupled electrical grid, a local load, or other coupled systems are capable of accepting or consuming at a given time. This excess energy, commonly referred to as curtailed energy, is typically wasted without producing any beneficial output, representing a significant and growing economic and environmental liability for renewable energy operators.

Conventional water supply systems, meanwhile, rely on surface water, groundwater, or energy-intensive desalination processes, each of which is subject to geographic constraints, infrastructure requirements, and increasing scarcity pressures driven by population growth and climate change. Atmospheric water generators (AWGs), which extract water from ambient air, offer a geographically unconstrained source of fresh water but generally have to be supported by a reliable and continuous supply of electrical energy to operate, making standalone AWG deployment prohibitively expensive in many contexts when powered from the electrical grid at standard market rates. Conventional pumped hydroelectric energy storage systems, one of the few established large-scale technologies capable of storing substantial quantities of energy, require significant energy input to pump water from a lower elevation to a higher elevation before the resulting gravitational potential energy can be recovered, introducing additional energy conversion losses and capital costs.

Currently, the generation of water from atmospheric moisture, a process accomplished by atmospheric water generators (AWGs), is an energy-intensive process that has to be supported by a reliable source of electrical power to operate continuously and efficiently. AWG systems deployed in isolation from renewable energy sources generally draw power from the electrical grid at standard market rates, making the cost of atmospherically-produced water prohibitively high in many contexts.

### SUMMARY

Embodiments described herein relate generally to systems and methods for atmospheric water generation at elevation In some embodiments, a system may include at least one renewable energy source capable of producing electrical power from a renewable resource. In some embodiments, the system may include an atmospheric water generator (AWG) apparatus configured to extract water from ambient air. In some embodiments, the system may include a control unit operatively connected to the renewable energy source and the AWG apparatus, the control unit being configured to monitor power output of the renewable source and detect when available power exceeds demand or grid acceptance. In some embodiments, the system may include a power routing mechanism controlled by the control unit that diverts at least a portion of said excess available power to drive the AWG apparatus, thereby causing the AWG apparatus to generate liquid water using energy that would otherwise be curtailed.

In some embodiments, the system may include an atmospheric water generator (AWG) system located at a first elevation, the AWG system configured to generate water from ambient air. In some embodiments, the system may include a water storage and distribution system configured to store at least a portion of the water generated by the AWG system, the water storage and distribution system located at a second elevation equal to or less than the first elevation. In some embodiments, the system may include an energy generation system configured to receive at least a portion of the stored water from the water storage and distribution system and convert a potential energy of the received water into energy, the energy generation system disposed at a third elevation less than the first elevation and the second elevation.

In some embodiments, the system may further include an energy storage system configured to receive energy, store energy, and communicate at least a portion of the stored energy to the AWG system.

In some embodiments, the system may include at least one renewable energy system configured to generate energy from a renewable source. In some embodiments, the system may include a controller configured to monitor a power output of the renewable energy system and detect when the power output exceeds a predetermined demand threshold. In some embodiments, the system may include a water storage and distribution system configured to store water generated by the AWG system.

In some embodiments, a method may include identifying excess renewable energy. In some embodiments, the method may include communicating at least a portion of the identified excess renewable energy to an AWG system, the AWG system disposed at a first elevation. In some embodiments, the method may include generating water via the AWG system. In some embodiments, the method may include storing at least a portion of the generated water at the predetermined elevation threshold. In some embodiments, the method may include communicating at least a portion of the stored water down a gravitational potential energy gradient. In some embodiments, the method may include utilizing at least a portion of the gravitational potential energy released by the communicated water to do work on a system.

In some embodiments, a system includes: at least one renewable energy source; an atmospheric water generator (AWG) apparatus configured to extract water from ambient air, the AWG apparatus disposed at a predetermined elevation; a controller operably couplable to at least one of the renewable energy source or the AWG apparatus, the controller configured to monitor a power output of the renewable energy source and detect when the power output exceeds a predetermined demand threshold; and a power routing mechanism controllable by the controller, the power routing mechanism configured to divert at least a portion of the detected excess power output to the AWG apparatus.

In some embodiments, a method of producing water using curtailed renewable energy includes: generating an electrical energy using a renewable source; monitoring an electrical power grid or local load to identify when a surplus of renewable energy is present that would otherwise be curtailed; during times of identified surplus, automatically diverting electrical energy that exceeds immediate demand to an atmospheric water generation process, and using that energy to extract water from ambient air; collecting the water produced and storing it for usage; and during times when no surplus energy is available, reducing or halting the atmospheric water generation process to avoid drawing power needed by other loads.

In some embodiments, a method includes: identifying an excess renewable energy; communicating at least a portion of the identified renewable energy to an atmospheric water generator (AWG) system, the AWG system disposed at least at a first elevation; generating water via the AWG system; storing at least a portion of the generated water at the first elevation; communicating at least a portion of the stored water down a gravitational potential energy gradient to a second elevation lower than the first elevation; and utilizing at least a portion of gravitational potential energy released by the communicated at least the portion of the water to perform work on a system.

In some embodiments, a system includes: an atmospheric water generator (AWG) system located at a first elevation, the AWG system configured to generate water from ambient air; a water storage and distribution system configured to store at least a portion of the water generated by the AWG system, the water storage and distribution system located at a second elevation equal to or less than the first elevation; and an energy generation system configured to receive at least a portion of the stored water from the water storage and distribution system and convert a potential energy of the received water into energy, the energy generation system disposed at a third elevation less than the first elevation and the second elevation.

All combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1A is a block diagram of a system for atmospheric water generation at elevation, according to an embodiment.

FIG. 1B is a block diagram of a controller, according to an embodiment.

FIG. 1C is a schematic block diagram of a system for atmospheric water generation at elevation, according to an embodiment.

FIG. 1D is a schematic block diagram of a system for atmospheric water generation at elevation using renewable energy, according to an embodiment.

FIGS. 2A-2B are schematic diagrams of atmospheric water generators, according to various embodiments.

FIGS. 2C-2G are schematic block diagrams of membrane configurations for a membrane-based water extraction device, according to various embodiments.

FIG. 3 is a block diagram of a controller circuitry, according to an embodiment.

FIG. 4 is a block diagram of a method of atmospheric water generation at elevation, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for atmospheric water generation at elevation. In some embodiments, the system may include an atmospheric water generator (AWG) system located at a first elevation, the AWG system configured to generate water from ambient air. In some embodiments, the system may include a water storage and distribution system configured to store at least a portion of the water generated by the AWG system, the water storage and distribution system located at a second elevation equal to or less than the first elevation. In some embodiments, the system may include an energy generation system configured to receive at least a portion of the stored water from the water storage and distribution system and convert a potential energy of the received water into energy, the energy generation system disposed at a third elevation less than the first elevation and the second elevation. In some embodiments, the system may further include an energy storage system configured to receive energy, store energy, and communicate at least a portion of the stored energy to the AWG system.

Conventional systems for renewable energy generation and water supply operate largely in isolation from one another. Renewable energy installations such as wind farms and solar photovoltaic arrays routinely generate electrical energy in excess of what a coupled electrical grid, a local load, or other coupled systems are capable of accepting or consuming at a given time. This excess energy, commonly referred to as curtailed energy, is typically wasted without producing any beneficial output, representing a significant and growing economic and environmental liability for renewable energy operators. Conventional water supply systems, meanwhile, rely on surface water, groundwater, or energy-intensive desalination processes, each of which is subject to geographic constraints, infrastructure requirements, and increasing scarcity pressures driven by population growth and climate change. Atmospheric water generators (AWGs), which extract water from ambient air, offer a geographically unconstrained source of fresh water but generally use a reliable and continuous supply of electrical energy to operate, making standalone AWG deployment expensive in many contexts when powered from the electrical grid at standard market rates. Conventional pumped hydroelectric energy storage systems, one of the few established large-scale technologies capable of storing substantial quantities of energy, generally employ significant energy input to pump water from a lower elevation to a higher elevation before the resulting gravitational potential energy can be recovered, introducing additional energy conversion losses and capital costs.

However, conventional systems are insufficient in addressing the problems of curtailed renewable energy, water scarcity, and the desire for low-cost, large-scale energy storage in an integrated manner. Conventional renewable energy installations do not convert curtailed energy into a storable, recoverable resource, and instead generally waste the excess generation. Conventional AWG systems, when powered from the electrical grid, produce water at a cost that is uncompetitive with conventional water supply in most markets. Conventional pumped hydroelectric storage generally use a pre-existing elevation differential and a dedicated pumping infrastructure to raise water to the storage elevation, consuming additional energy in the process.

Hence, it would be advantageous to provide systems and methods that utilize curtailed renewable energy to generate water from ambient air at a meaningful elevation, store that water at or near the elevation at which it is generated, and subsequently recover the gravitational potential energy of the stored water as a useable form of energy, such that the water simultaneously serves as a potable water resource and as a medium for storing and recovering energy. Thus, the systems and methods may simultaneously address renewable energy curtailment, water scarcity, and the need for low-cost energy storage. Such systems and methods may also offer the ability to produce potable water as a co-product of the energy storage process, to operate without pumping water uphill, and to scale from community-level to utility-scale deployments. Additional considerations for systems designed for optimal performance in this context may include compatibility with intermittent renewable energy sources, modularity and scalability of the AWG system, the elevation differential achievable at a given deployment site, and the efficiency of the energy generation system used to recover the gravitational potential energy of the stored water.

However, conventional systems struggle to accomplish this combination of functions. Conventional renewable energy installations lack the control infrastructure to dynamically route curtailed energy to an AWG system located at elevation. Conventional AWG systems are not designed to be sited at elevation for the purpose of accumulating gravitational potential energy in the water they produce. Conventional pumped hydroelectric storage systems use energy input to raise water to the storage elevation, rather than generating water at elevation in the first instance. Thus, conventional systems do not utilize water generated from ambient air as a medium for storing and recovering the gravitational potential energy inherent in the water by virtue of the elevation at which it was generated.

In contrast, embodiments of the systems and methods for atmospheric water generation at elevation described herein, may provide one or more potential benefits, including, for example: 1) enabling the utilization of curtailed renewable energy that would otherwise be wasted; 2) enabling the generation of potable water from ambient air as a co-product of an energy storage process; 3) enabling the storage of gravitational potential energy in atmospherically-generated water without using any energy input to raise the water to the storage elevation, because the water is generated at elevation; 4) enabling the recovery of the gravitational potential energy of the stored water as electrical energy, mechanical energy, or any other form of useable energy; 5) enabling the system to remain water positive, such that the AWG system may generate more water than is consumed by the energy generation process; 6) enabling grid stability support by operating the AWG system as a flexible, controllable load that may be ramped up or down in response to grid frequency, voltage, or curtailment signals; 7) enabling deployment in water-scarce regions that also have abundant renewable energy resources, such as arid and semi-arid regions with strong wind or solar resources; 8) enabling modular and scalable deployment, from community-scale systems serving hundreds of people to utility-scale systems serving large populations or industrial users; 9) enabling the system to operate without the geographic constraints of conventional pumped hydroelectric storage; 10) enabling the production of naturally distilled, high-purity water that may be suitable for potable, agricultural, or industrial uses with minimal treatment; 11) enabling the system to provide ancillary grid services, such as frequency regulation and demand response, by modulating the power consumption of the AWG system in response to grid conditions; 12) enabling the system to be integrated with a variety of renewable energy sources, including wind turbines, solar photovoltaic arrays, and hybrid wind-solar installations; 13) enabling the system to be deployed in remote or off-grid locations where conventional water supply and energy storage infrastructure is unavailable or prohibitively expensive; 14) enabling the system to reduce the carbon footprint of water production, because the water is generated using renewable energy; and 15) enabling the system to provide a new revenue stream for renewable energy operators by converting curtailed energy into a saleable water resource and a dispatchable energy storage asset.

As used herein, curtailed renewable energy refers to excess and/or unused renewable energy, that is, renewable energy generated by a renewable energy source that cannot be supplied to an electrical grid or a primary load without overloading the grid or load. For example, a renewable energy source may produce or have the capacity to produce more energy than the electrical grid 108 or a primary load can accept or consume at a given time. Curtailed renewable energy may include excess wind energy resulting from overproduction during windy conditions when demand is low (e.g., strong winds at night when consumption is reduced) and/or excess solar energy resulting from overproduction during sunny conditions when demand is low (e.g., midday solar oversupply), which in conventional systems may force the renewable energy source to be throttled or shut off.

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the term “set” and “plurality” can refer to multiple features or a singular feature with multiple parts. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the terms “about” and “approximately” generally mean plus or minus 10% of the stated value. For example, about 0.5 would include 0.45 and 0.55, about 10 would include 9 to 11, about 1,000 would include 900 to 1,100.

As used herein, the terms “substantially” and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “substantially” when used in connection with a numeric parameter is intended to convey that the numeric parameter may vary by about plus or minus about 5%. For example, the term “substantially uniform pressure” implies that the pressure applied may vary ±5% across the entire surface or volume being considered.

The terms “coupled,” and the like as used herein mean the joining of two members directly or indirectly to one another. Such joining may be stationary (e.g., permanent) or moveable (e.g., removable, or releasable). Such joining may be achieved with the two members, or the two members and any additional intermediate members being integrally formed as a single unitary body with one another or with the two members or the two members and any additional intermediate members being attached to one another.

As used herein, the term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples).

As used herein, the term “including,” “comprising,” or “having,” “containing,” “involving” and variations thereof herein, is meant to encompass the items listed thereafter as well as, optionally, additional items. In the description the same numerical references refer to similar elements.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, the term “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

All definitions, as defined and used herein, should be understood to control over dictionary definitions, definitions in documents incorporated by reference, and/or ordinary meanings of the defined terms.

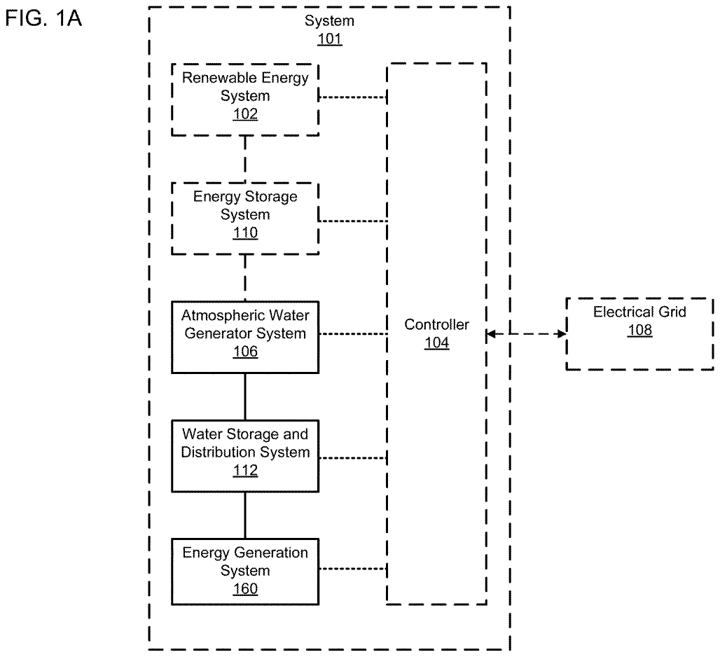

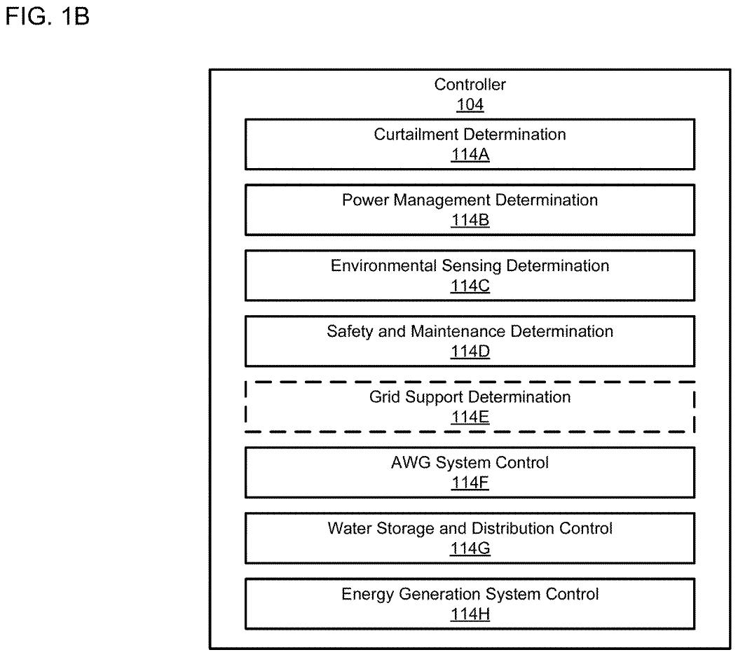

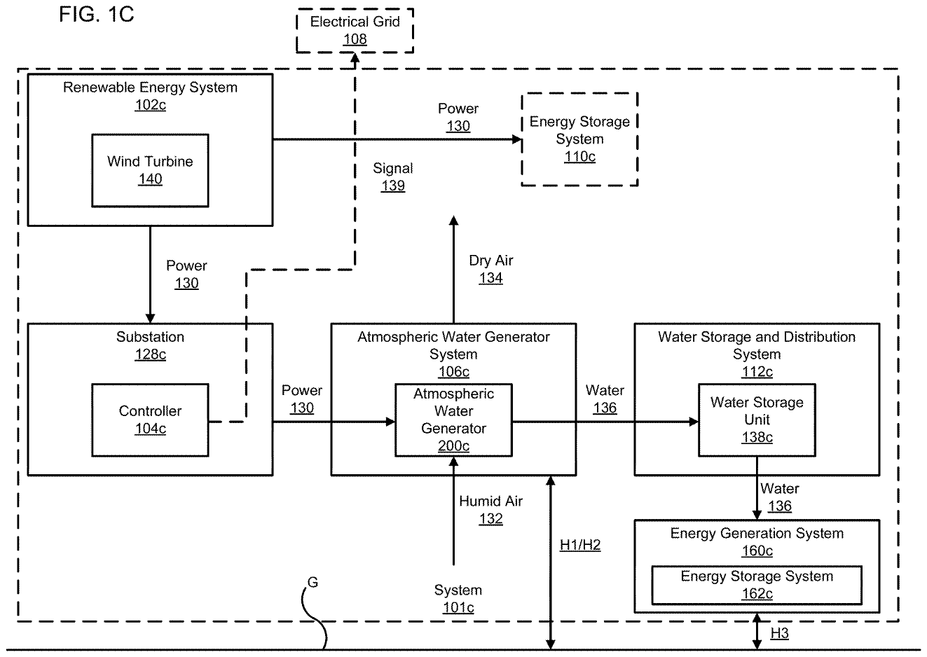

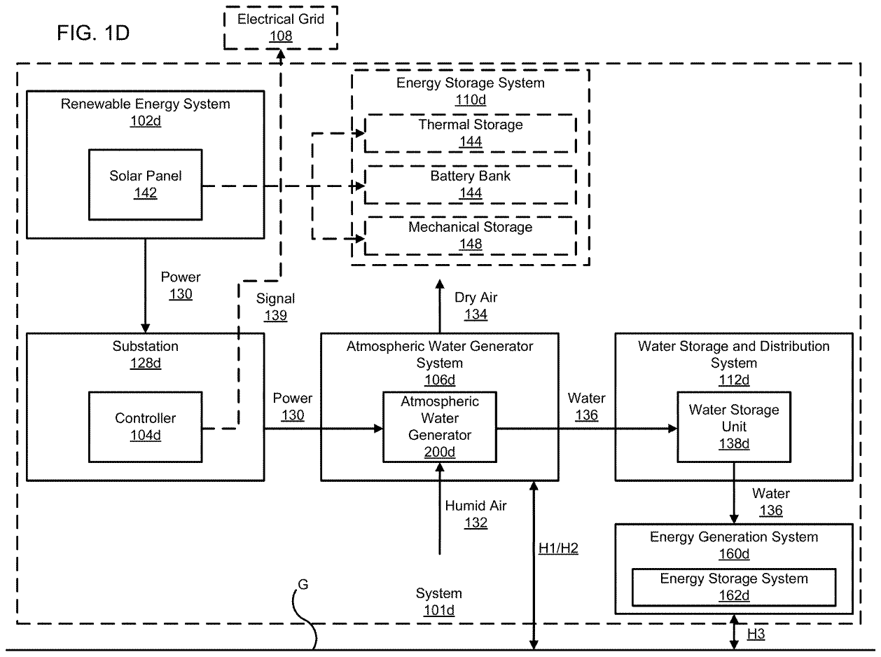

FIG. 1A is a block diagram of a system 101 for atmospheric water generation at elevation, according to an embodiment. In some embodiments, the system 101 may include an atmospheric water generator (AWG) system 106, a water storage and distribution system 112, and an energy generation system 160. In some embodiments, the system 101 may optionally include a controller 104, a renewable energy system 102, and/or an energy storage system 110. In some embodiments, the system 101 may be operably couplable with one or more electrical grids 108 (e.g., a utility grid, a grid, or any other suitable grid structure).

In some embodiments, the renewable energy system 102 may be configured to generate energy. In some embodiments, the renewable energy system 102 may include one or more renewable energy sources. For example, in some embodiments, the renewable energy system 102 may include at least one of a wind energy (e.g., wind turbines or other wind-based renewable energy sources), a solar energy (e.g., generated using solar panels or the like), and/or any other suitable renewable energy source. In some embodiments, the renewable energy system 102 may be configured to communicate with one or more other subsystems of the system 101 (i.e., the energy storage system 110, the AWG system 106, the water storage and distribution system 112, the energy generation system 160, and/or the controller 104). In some embodiments, the renewable energy system 102 may be configured to supply energy to the AWG system 106, the energy storage system 110, the electrical grid 108, and/or any other coupled system. In some embodiments, the renewable energy system 102 may be a discrete system (e.g., a discrete renewable energy source) separate from the electrical grid 108. In some embodiments, the renewable energy system 102 may be part of the electrical grid 108 (e.g., part of the electrical grid system).

In some embodiments, the system 101 may include the AWG system 106. In some embodiments, the AWG system 106 may be configured to extract water from ambient air. In some embodiments, the AWG system 106 may be configured to extract moisture from the air to produce liquid water (e.g., potable water). In some embodiments, the AWG system 106 may be configured to generate more water than is consumed by the energy generation process, such that a net water gain is achieved over time. In some embodiments, the AWG system 106 may be configured to produce water from ambient air at any suitable production rate. In some embodiments, the AWG system 106 may be configured to produce water from ambient air at a rate of about 500 liters per day to about 4×10⁸ liters per day, inclusive of all values and ranges therebetween. For example, in some embodiments, the AWG system 106 may be configured to produce water from ambient air at a rate of at least about 500 liters per day, at least about 1,000 liters per day, at least about 2,500 liters per day, at least about 5,000 liters per day, at least about 10,000 liters per day, at least about 25,000 liters per day, at least about 50,000 liters per day, at least about 75,000 liters per day, at least about 100,000 liters per day, at least about 150,000 liters per day, at least about 200,00liters per day, at least about 250,000 liters per day, at least about 300,000 liters per day, at least about 350,000 liters per day, at least about 400,000 liters per day, at least about 450,000 liters per day, at least about 500,000 liters per day, at least about 1 million liters per day (i.e., at least about 1×10⁶ liters per day), at least about 2 million liters per day at least about 3 million liters per day, at least about 4 million liters per day, at least about 5 million liters per day, at least about 10 million liters per day (i.e., at least about 1×10⁷ liters per day), at least about 15 million liters per day, at least about 20 million liters per day, at least about 25 million liters per day, at least about 50 million liters per day, at least about 75 million liters per day, at least about 100 million liters per day (i.e., at least about 1×10⁸ liters per day), at least about 200 million liters per day, at least about 300 million liters per day, or at least about 380 million liters per day (i.e., at least about 3.8×10⁸ liters per day). In some embodiments, the AWG system 106 may be configured to produce water from ambient air at a rate of no more than about 380 million liters per day (i.e., no more than about 3.8×10⁸ liters per day), no more than about 300 million liters per day, no more than about 200 million liters per day, no more than about 100 million liters per day (i.e., no more than about 1×10⁸ liters per day), no more than about 75 million liters per day, no more than about 50 million liters per day, no more than about 25 million liters per day, no more than about 20 million liters per day, no more than about 15 million liters per day, no more than about 10 million liters per day (i.e., no more than about 1×10⁷ liters per day), no more than about 5 million liters per day, no more than about 4 million liters per day, no more than about 3 million liters per day, no more than about 2 million liters per day, no more than about 1 million liters per day (i.e., no more than about 1×10⁶ liters per day), no more than about 500,000 liters per day, no more than about 450,000 liters per day, no more than about 400,000 liters per day, no more than about 350,000 liters per day, no more than about 300,000 liters per day, no more than about 250,000 liters per day, no more than about 200,000 liters per day, no more than about 150,000 liters per day, no more than about 100,000 liters per day, no more than about 75,000 liters per day, no more than about 50,000 liters per day, no more than about 25,000 liters per day, no more than about 10,000 liters per day, no more than about 5,000 liters per day, no more than about 2,500 liters per day, no more than about 1,000 liters per day, or no more than about 500 liters per day. Combinations of the above-referenced water production rates are also possible (e.g., at least about 500 liters per day and no more than about 380 million liters per day, or at least about 100,000 liters per day and no more than about 10 million liters per day), inclusive of all values and ranges therebetween. All such variations are envisioned herein and should be considered as part of the present disclosure.

In some embodiments, the AWG system 106 may be located at a first elevation. In some embodiments, the first elevation may be selected such that the AWG system 106 is positioned at or proximate to a hilltop, a mountain ridge, an elevated plateau, a tall structure, or any other elevated region from which water generated by the AWG system 106 may be communicated to a region of lower elevation. In some embodiments, the first elevation may be defined with respect to a reference datum, such as sea level, or with respect to the third elevation at which the energy generation system 160 is disposed.

In some embodiments, the AWG system 106 may be configured to operate using energy received from the renewable energy system 102 and/or the energy storage system 110. In some embodiments, the AWG system 106 may be configured to operate primarily using curtailed energy from the renewable energy system 102, that is, energy generated by the renewable energy system 102 in excess of what is demanded by the electrical grid 108, a local load, or other coupled systems.

In some embodiments, the AWG system 106 may include an air handling system (e.g., fans, blowers, and/or ducting,). In some embodiments, the AWG system 106 may be configured to draw in an air stream of ambient air via the air handling system. In some embodiments, the AWG system 106 may include a moisture extraction system (e.g., a refrigeration cycle, a desiccant cycle, a membrane-based extraction system, and/or any suitable combination thereof.). In some embodiments, the AWG system 106 may include a water collection and purification system (e.g., filters, UV sterilizer or ozonation, and/or a mineralization cartridge), and/or one or more water storage tanks. In some embodiments, the AWG system 106 may include a single large AWG or an array of several AWGs working in parallel. In some embodiments, the AWG system 106 may include a plurality AWG units, each of which may be independently activated, deactivated, ramped up, or ramped down by the controller 104 based on the amount of curtailed energy available from the renewable energy system 102 and/or the energy storage system 110. In some embodiments, the AWG system 106 may be configured to communicate at least a portion of a water output thereof to the water storage and distribution system 112. In some embodiments, the AWG system 106 may be configured to produce an output including a potable water. In some embodiments, the output of the AWG system 106 may include dry air as a byproduct of the water extraction process.

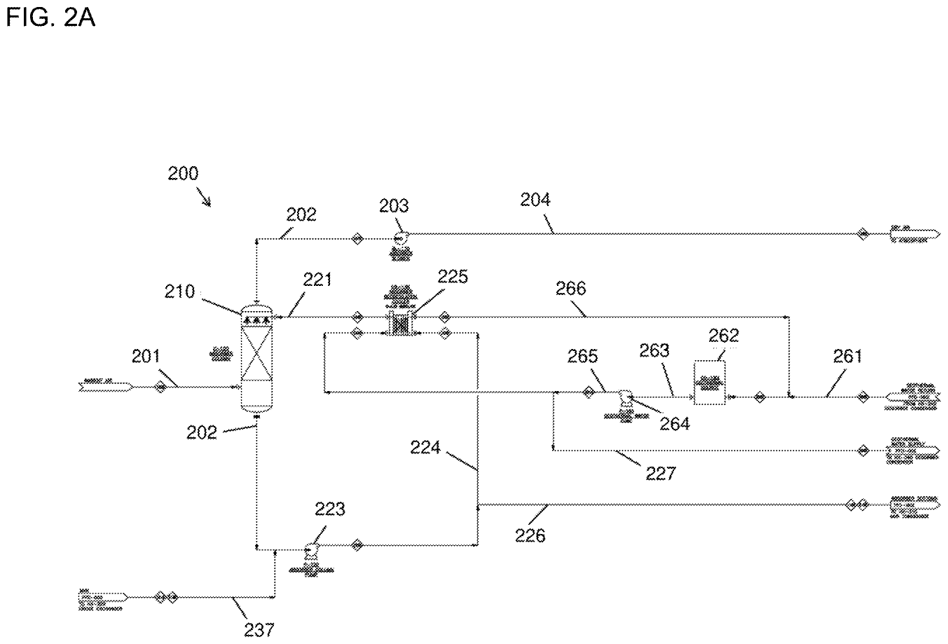

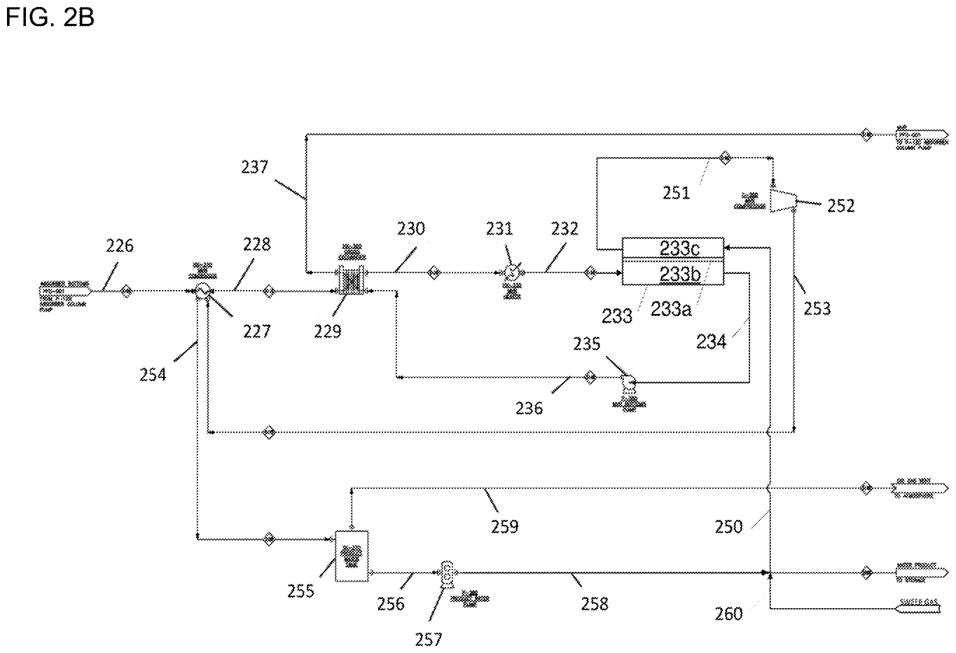

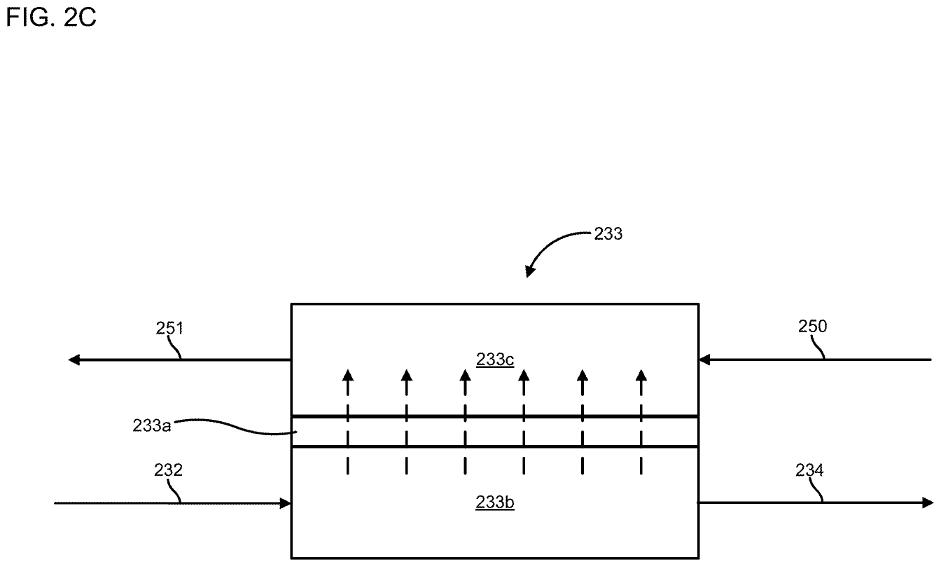

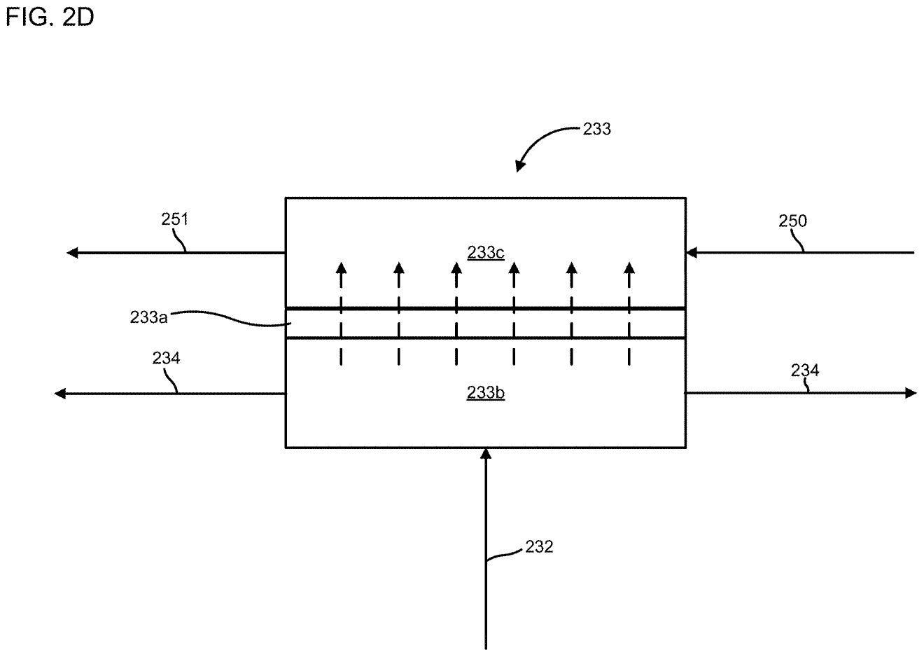

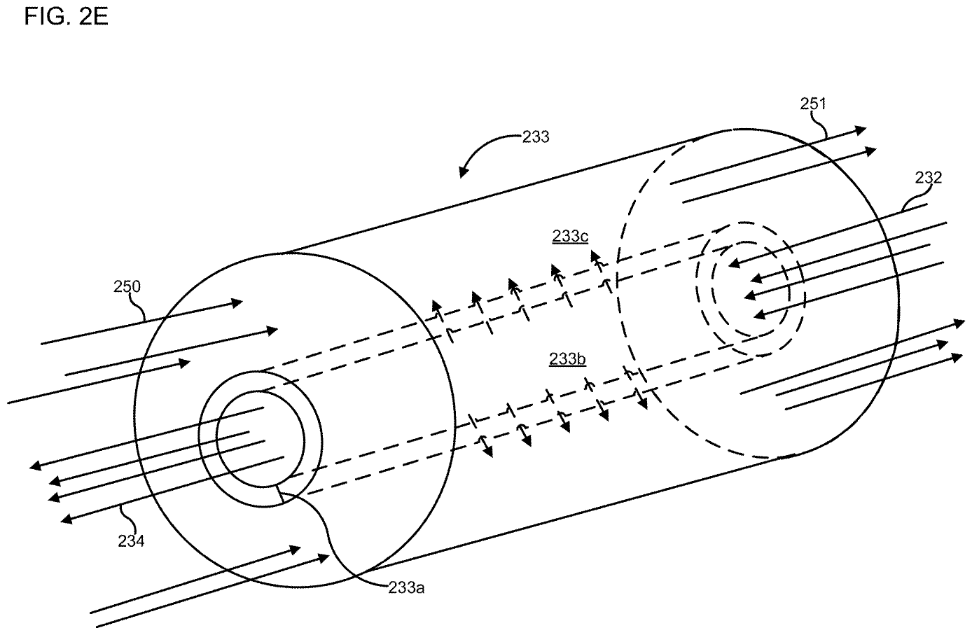

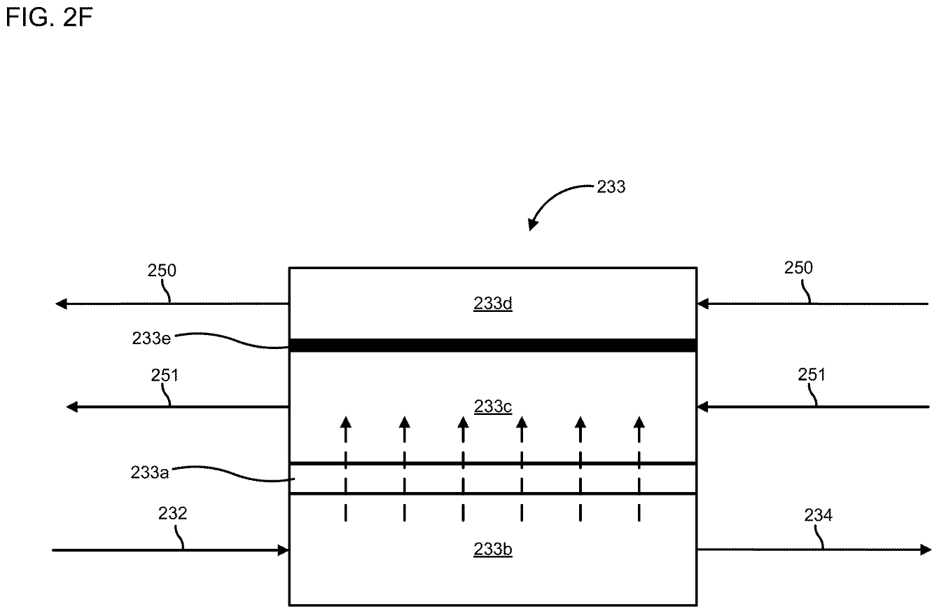

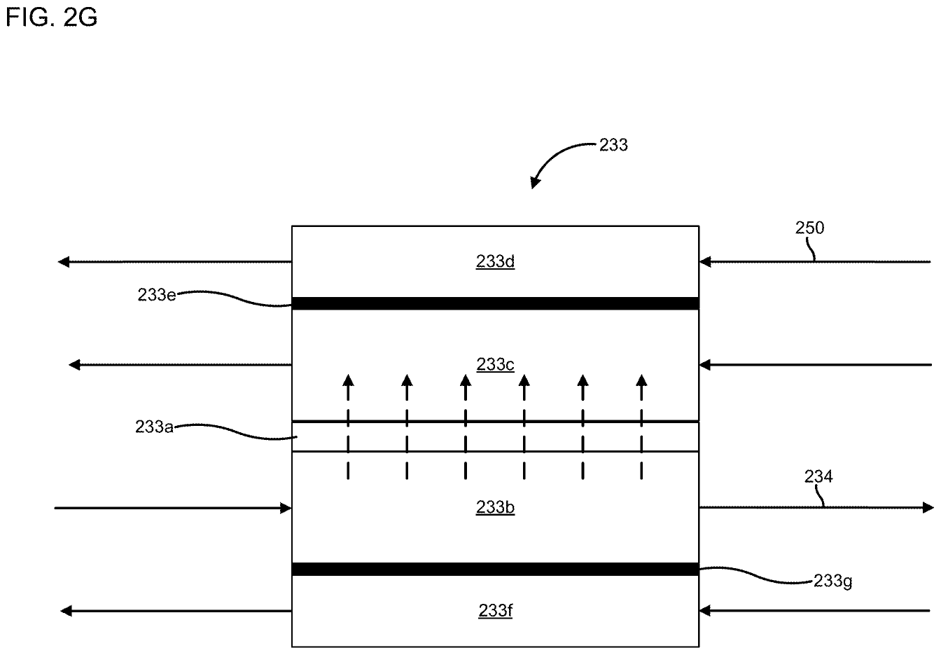

In some embodiments, the AWG system 106 may be configured to capture water vapor from ambient air and condense it into liquid water. In some embodiments, the AWG system 106 may be configured to cool an inlet stream of ambient air below its dew point to condense water vapor into liquid water. For example, in some embodiments, the AWG system 106 may include a vapor-compression refrigeration cycle having a compressor, a condenser coil, an expansion device, and an evaporator coil. In some embodiments, the AWG system 106 may include a turbine expander configured to recover energy during expansion of an internal refrigerant, thereby improving the overall coefficient of performance of the cooling cycle. In some embodiments, the AWG system 106 may be configured to extract water vapor from ambient air via a desiccant, for example, in which hygroscopic materials are used to absorb water vapor from ambient air at ambient conditions, and heat is subsequently applied to release the absorbed water for condensation. In some embodiments, the AWG system 106 may include a membrane-based water extraction component, as further described herein with reference to FIGS. 2A-2G. In some embodiments, the AWG system 106 may be configured to employ a hybrid technique that leverages two or more of the foregoing techniques, individually or in parallel, to capture water vapor from ambient air and condense it into liquid water. In some embodiments, the AWG system 106 may include a purification system (e.g., UV sterilization, ozonation, and/or carbon filtration) prior to ensure the water generated thereby is potable. In some embodiments, the AWG system 106 may be configured to communicate at least a portion of the water generated thereby to the water storage and distribution system 112. For example, in some embodiments, the AWG system 106 may be configured to communicate at least a portion of the water generated thereby to the water storage and distribution system 112 via gravity or with minimal pumping energy.

In some embodiments, the water storage and distribution system 112 may be configured to receive at least a portion of the water generated by the AWG system 106. In some embodiments, the water storage and distribution system 112 may be configured to store at least a portion of the water generated by the AWG system 106. In some embodiments, the water storage and distribution system 112 may include one or more water storage units (e.g., water tanks, reservoirs, basins, dams, cisterns, or any other suitable water storage vessel or structure). In some embodiments, the water storage and distribution system 112 may be configured to store any suitable volume of water. For example, in some embodiments, the water storage and distribution system 112 may be configured to store a volume of water of in a range of about 10,000 liters to about 500,000,000 liters, inclusive of all values and ranges therebetween. In some embodiments, the water storage and distribution system 112 may be configured to store a volume of water of at least about 10,000 liters, at least about 25,000 liters, at least about 50,000 liters, at least about 100,000 liters, at least about 250,000 liters, at least about 500,000 liters, at least about 1,000,000 liters, at least about 5,000,000 liters, at least about 10,000,000 liters, at least about 25,000,000 liters, at least about 50,000,000 liters, at least about 100,000,000 liters, at least about 150,000,000 liters, at least about 200,000,000 liters, at least about 250,000,000 liters, at least about 300,000,000 liters, at least about 350,000,000 liters, at least about 400,000,000 liters, or at least about 450,000,000 liters. In some embodiments, the water storage unit 138 may be configured to store a volume of water of no more than about 500,000,000 liters, no more than about 450,000,000 liters, no more than about 400,000,000 liters, no more than about 350,000,000 liters, no more than about 300,000,000 liters, no more than about 250,000,000 liters, no more than about 200,000,000 liters, no more than about 150,000,000 liters, no more than about 100,000,000 liters, no more than about 50,000,000 liters, no more than about 25,000,000 liters, no more than about 10,000,000 liters, no more than about 5,000,000 liters, no more than about 1,000,000 liters, no more than about 500,000 liters, no more than about 250,000 liters, no more than about 100,000 liters, no more than about 50,000 liters, no more than about 25,000 liters, or no more than about 10,000 liters. Combinations of the above-referenced storage volumes are also possible (e.g., at least about 10,000 liters and no more than about 500,000,000 liters, or at least about 500,000 liters and no more than about 50,000,000 liters), inclusive of all values and ranges therebetween. All such variations are envisioned herein and should be considered as part of the present disclosure.

In some embodiments, the water storage and distribution system 112 may be located at a second elevation equal to or less than the first elevation of the AWG system 106. In some embodiments, the water storage and distribution system 112 may be located at an elevation that is similar to or substantially the same as the AWG system 106. In some embodiments, the water storage and distribution system 112 may be located at an elevation lower than the first elevation of the AWG system 106.

In some embodiments, the water storage and distribution system 112 may be configured to communicate at least a portion of the water stored therein to the energy generation system 160. In some embodiments, the water storage and distribution system 112 may be fluidically coupled with the energy generation system 160. In some embodiments, the water storage and distribution system 112 may be configured to store and distribute a volume of water sufficient to drive the energy generation system 160 at a predetermined power output for a predetermined duration of time when communicated thereto.

In some embodiments, the water storage and distribution system 112 may be configured to deliver stored water for end use, such as for potable water distribution, agricultural irrigation, industrial processes, or any other suitable end use. For example, in some embodiments, the water storage and distribution system 112 may include a distribution system including at least one of a pipeline connecting the water storage and distribution system 112 to a municipal water network, a tanker filling station configured to transport water off-site, or a dispensing outlet for local consumption.

In some embodiments, the water storage and distribution system 112 may be configured to communicate water to the energy generation system 160 at any suitable flow rate. For example, in some embodiments, the water storage and distribution system 112 may be configured to communicate water to the energy generation system 160 at a flow rate in a range of about 0.1 liters per second to about 10,000 liters per second, inclusive of all values and ranges therebetween. In some embodiments, the water storage and distribution system 112 may be configured to communicate water to the energy generation system 160 at a flow rate at least about 0.1 liters per second, at least about 0.5 liters per second, at least about 1 liter per second, at least about 2.5 liters per second, at least about 5 liters per second, at least about 10 liters per second, at least about 25 liters per second, at least about 50 liters per second, at least about 100 liters per second, at least about 250 liters per second, at least about 500 liters per second, at least about 750 liters per second, at least about 1,000 liters per second, at least about 2,500 liters per second, at least about 5,000 liters per second, at least about 6,000 liters per second, at least about 7,000 liters per second, at least about 8,000 liters per second, or at least about 9,000 liters per second. In some embodiments, the water storage and distribution system 112 may be configured to communicate water to the energy generation system 160 at a flow rate of no more than about 10,000 liters per second, no more than about 9,000 liters per second, no more than about 8,000 liters per second, no more than about 7,000 liters per second, no more than about 6,000 liters per second, no more than about 5,000 liters per second, no more than about 2,500 liters per second, no more than about 1,000 liters per second, no more than about 750 liters per second, no more than about 500 liters per second, no more than about 250 liters per second, no more than about 100 liters per second, no more than about 50 liters per second, no more than about 25 liters per second, no more than about 10 liters per second, no more than about 5 liters per second, no more than about 2.5 liters per second, no more than about 1 liter per second, no more than about 0.5 liters per second, or no more than about 0.1 liters per second. Combinations of the above-referenced flow rates are also possible (e.g., at least about 0.1 liters per second and no more than about 10,000 liters per second, or at least about 1 liter per second and no more than about 1,000 liters per second), inclusive of all values and ranges therebetween. All such variations are envisioned herein and should be considered as part of the present disclosure.

In some embodiments, the water storage and distribution system 112 may be operably coupled with the controller 104. In some embodiments, the water storage and distribution system 112 may be configured to receive a signal from the controller 104. In some embodiments, the water storage and distribution system 112 may be configured to communicate at least a portion of the water stored therein to the energy generation system 160 based on a signal received from the controller 104.

In some embodiments, the energy generation system 160 may be configured to receive at least a portion of the stored water from the water storage and distribution system 112. In some embodiments, the energy generation system 160 may be configured to convert at least a portion of the gravitational potential energy of the received water into one or more forms of usable energy. For example, in some embodiments, the energy generation system 160 may configured to convert at least a portion of the gravitational potential energy of the received water into one or more of a mechanical energy, a thermal energy, an electrical energy, a chemical energy, an optical energy, a kinetic energy, or any other suitable form of energy. In some embodiments, the energy generation system 160 may be located at a third elevation less than the first elevation of the AWG system 106 and less than the second elevation of the water storage and distribution system 112.

In some embodiments, the first elevation and/or the second elevation may have an elevation difference relative to the third elevation of any suitable value. In some embodiments the elevation differential between the first and/or second elevation and the third elevation may be in a range of about 10 meters to about 2,000 meters (i.e., 2 kilometers), inclusive of all values and ranges therebetween. For example, in some embodiments, the first and second elevation and the third elevation may have an elevation difference of at least about 10 meters, at least about 25 meters, at least about 50 meters, at least about 75 meters, at least about 100 meters, at least about 150 meters, at least about 200 meters, at least about 300 meters, at least about 400 meters, at least about 500 meters, at least about 600 meters, at least about 700 meters, at least about 800 meters, at least about 900 meters, at least about 1,000 meters, at least about 1,100 meters, at least about 1,200 meters, at least about 1,300 meters, at least about 1,400 meters, at least about 1,500 meters, at least about 1,600 meters, at least about 1,700 meters, at least about 1,800 meters, or at least about 1,900 meters. In some embodiments, the elevation difference between the first or the second elevation and the third elevation may be no more than about 2,000 meters, no more than about 1,900 meters, no more than about 1,800 meters, no more than about 1,700 meters, no more than about 1,600 meters, no more than about 1,500 meters, no more than about 1,400 meters, no more than about 1,300 meters, no more than about 1,200 meters, no more than about 1,100 meters, no more than about 1,000 meters, no more than about 900 meters, no more than about 800 meters, no more than about 700 meters, no more than about 600 meters, no more than about 500 meters, no more than about 400 meters, no more than about 300 meters, no more than about 200 meters, no more than about 150 meters, no more than about 100 meters, no more than about 75 meters, no more than about 50 meters, or no more than about 25 meters. Combinations of the above-referenced elevation differentials are also possible (e.g., at least about 10 meters and no more than about 2,000 meters, or at least about 50 meters and no more than about 1,000 meters), inclusive of all values and ranges therebetween. All such variations are envisioned herein and should be considered as part of the present disclosure.

In some embodiments, as water is communicated from the second elevation to the third elevation, the gravitational potential energy of the water, (i.e., energy that is inherent in the water by virtue of the elevation at which it was generated and stored) is released and may be converted by the energy generation system 160 into electrical energy, mechanical energy, thermal energy, or any other form of useable energy. Without wishing to be bound by any particular theory, in some embodiments, the energy generation system 160 may include one or more energy conversion devices configured to convert the kinetic energy of moving water, derived from the gravitational potential energy of the water as it descends from the first and/or the second elevation to the third elevation, into useable energy. Thus, the system 101 advantageously allows for storage of usable potential energy in the form of water generated at the first elevation, which can be used later to generate electrical energy or converted into some other form of energy as desired. Moreover, the generated water can also be used as potable water for communities located proximate to the AWGS 106.

In some embodiments, the energy generation system 160 may include a turbine-based hydropower system. For example, in some embodiments, the energy generation system 160 may include a Pelton wheel, a Francis turbine, a Kaplan turbine, or any other suitable hydraulic turbine configured to be driven by the flow of water communicated from the water storage and distribution system 112. In some embodiments, the energy generation system 160 may include a pump-as-turbine configuration, wherein a pump is operated in reverse to function as a turbine and generate electrical energy from the flow of water. In some embodiments, the energy generation system 160 may include a piezoelectric transducer configured to convert mechanical vibrations or pressure pulses generated by the flowing water into electrical energy. In some embodiments, the energy generation system 160 may be configured to store at least a portion of the energy generated by the energy generation system 160. For example, in some embodiments, the energy generation system 160 may include one or more batteries, capacitors, supercapacitors, flywheels, compressed air storage units, or any other suitable energy storage device or system. All such variations are envisioned herein and should be considered as part of the present disclosure.

In some embodiments, the energy generation system 160 may be configured to communicate at least a portion of the converted energy to one or more other systems. For example, in some embodiments, the energy generation system 160 may be configured to communicate at least a portion of the converted energy to the AWG system 106, thereby partially or fully powering the AWG system 106 with energy recovered from the gravitational potential energy of the water generated by the AWG system 106. In some embodiments, the energy generation system 160 may be configured to communicate at least a portion of the converted energy to the energy storage system 110. In some embodiments, the energy generation system 160 may be configured to communicate at least a portion of the converted energy to the electrical grid 108, or to any other coupled system or load. In some embodiments, the energy generation system 160 may be configured to communicate at least a portion of the converted energy to the AWG system 106 and/or the energy storage system 110 during periods when the renewable energy system 102 is not generating sufficient energy to power the AWG system 106 directly.

In some embodiments, the energy generation system 160 may be configured to have any suitable power output. For example, in some embodiments, the energy generation system 160 may be configured to generate a power output in a range of about 1 kilowatt (kW) to about 500,000 kW, inclusive of all values and ranges therebetween. In some embodiments, the energy generation system 160 may be configured to generate a power output of at least about 1 kW, at least about 5 kW, at least about 10 kW, at least about 25 kW, at least about 50 kW, at least about 100 kW, at least about 250 kW, at least about 500 kW, at least about 1,000 kW, at least about 2,500 kW, at least about 5,000 kW, at least about 10,000 kW, at least about 25,000 kW, at least about 50,000 kW, at least about 75,000 kW, at least about 100,000 kW, at least about 150,000 kW, at least about 200,000 kW, at least about 250,000 kW, at least about 300,000 kW, at least about 350,000 kW, at least about 400,000 kW, or at least about 450,000 kW. In some embodiments, the energy generation system 160 may be configured to generate a power output of no more than about 500,000 kW, no more than about 450,000 kW, no more than about 400,000 kW, no more than about 350,000 kW, no more than about 300,000 kW, no more than about 250,000 kW, no more than about 200,000 kW, no more than about 150,000 kW, no more than about 100,000 kW, no more than about 75,000 kW, no more than about 50,000 kW, no more than about 25,000 kW, no more than about 10,000 kW, no more than about 5,000 kW, no more than about 2,500 kW, no more than about 1,000 kW, no more than about 500 kW, no more than about 250 kW, no more than about 100 kW, no more than about 50 kW, no more than about 25 kW, no more than about 10 kW, no more than about 5 k, or no more than about 1 kW. Combinations of the above-referenced power outputs are also possible (e.g., at least about 1 kW and no more than about 500,000 kW, or at least about 100 kW and no more than about 50,000 kW), inclusive of all values and ranges therebetween. All such variations are envisioned herein and should be considered as part of the present disclosure.

In some embodiments, the system 101 may optionally include an energy storage system 110. In some embodiments, the energy storage system 110 may be configured to receive energy from the renewable energy system 102 and/or the energy generation system 160, store energy, and communicate at least a portion of the stored energy to the AWG system 106, the electrical grid 108 and/or any other coupled systems. In some embodiments, the energy storage system 110 may be configured to store a surplus energy during periods of high renewable energy output and supplying that stored energy to the AWG system 106 during periods of low renewable energy output. In some embodiments, the energy storage system 110 may include one or more energy storage units. In some embodiments, the energy storage system 110 may include at least one of electrochemical energy storage (e.g., batteries, capacitors, or any other suitable device to store electrochemical energy), thermal energy storage (e.g., chilled water or ice banks configured to store cooling energy), or mechanical energy storage (e.g., flywheels, compressed air, and/or any other suitable structure).

In some embodiments, the system 101 may optionally include a controller 104 (also referred to herein as a control unit or control system). In some embodiments, the controller 104 may be operably coupled with the electrical gird 108 and/or one or more subsystems of the system 101 (i.e., the energy storage system 110, the AWG system 106, the water storage and distribution system 112, the energy generation system 160, and/or the renewable energy system 102). In some embodiments, the controller 104 may be configured to coordinate the operation of one or more of the AWG system 106, the water storage and distribution system 112, the energy generation system 160, the renewable energy system 102, the energy storage system 110, and/or the electrical grid 108. In some embodiments, the controller 104 may include power electronics (e.g., switches, inverters, converters, breakers, and/or other power electronics) and a control logic. In some embodiments, the controller 104 may be configured to send a signal to the water storage and distribution system 112 to release at least a portion of the water stored therein to the energy generation system 160 based on one or more conditions (e.g., detecting that the volume of water within the water storage and distribution system 112 has reached a predetermined threshold level, receiving a demand signal from the energy generation system 160 or another coupled system, or any other suitable triggering condition).

In some embodiments, the controller 104 may be configured to dynamically route (e.g., divert, redirect, or transfer) excess energy generated by the renewable energy system 102 to the AWG system 106 for water production. In some embodiments, the controller 104 may be configured to monitor the renewable energy system 102 (e.g., monitor an output of renewable energy sources thereof) and the status of the electrical grid 108.

In some embodiments, the electrical grid 108 may be configured to receive energy from the renewable energy system 102. In some embodiments, the electrical grid 108 may be configured to supply energy to the AWG system 106. In some embodiments, the controller 104 may be configured to monitor the electrical grid 108, for example, to detect curtailment conditions and/or to receive signals or commands from the electrical grid 108 indicative of a curtailment condition or an instruction to absorb a certain amount of energy.

FIG. 1B is a block diagram of the controller 104, according to an embodiment. In some embodiments, the controller 104 may include a curtailment determination 114A, a power management determination 114B, an environmental sensing determination 114C, a safety and maintenance determination 114D, a grid support determination 114E, an AWG system control 114F, a water storage and distribution control 114G, and an energy generation system control 114H. In some embodiments, the controller 104 may be configured as a distributed system, such that two or more of the curtailment determination 114A, the power management determination 114B, the environmental sensing determination 114C, the safety and maintenance determination 114D, the grid support determination 114E, the AWG system control 114F, the water storage and distribution control 114G, and/or the energy generation system control 114H may be distributed across one or more subsystems of the system 101. In some embodiments, one or more of these determinations and controls may be configured to operate concurrently to provide coordinated, multi-functional control of the system 101 and the subsystems thereof.

In some embodiments, the controller 104 may include the curtailment determination 114A. In some embodiments, the curtailment determination 114A may be configured to detect a curtailment condition and, in response, cause power to be redirected to the AWG system 106. In some embodiments, a curtailment condition may refer to an occurrence where the energy generated by the renewable energy system 102 exceeds the energy demand of the electrical grid 108 or a primary load. In some embodiments, the curtailment determination 114A may be configured to monitor the electrical grid 108 or a primary load to detect whether the electrical grid 108 has reached a threshold amount of renewable energy that it can accept without overloading. In some embodiments, the curtailment determination 114A may be configured to receive grid signals from the electrical grid 108 indicative of a curtailment condition, or alternatively to detect local overproduction by the renewable energy system 102 directly. In some embodiments, the curtailment determination 114A may be configured to receive a grid request from a grid operator via an application programming interface (API), the grid request being indicative of a curtailment condition or an instruction to redirect a certain amount of energy to the AWG system 106. In some embodiments, the curtailment determination 114A may include an artificial intelligence (AI)-based prediction model configured to predict when curtailment is likely, for example, based on weather forecasts, historical generation data, and/or real-time grid conditions.

In some embodiments, the controller 104 may include the power management determination 114B. In some embodiments, the power management determination 114B may be configured to distribute energy from the renewable energy system 102 to the AWG system 106 and/or the energy storage system 110, and to ramp up or ramp down the AWG system 106 based on the amount of curtailed energy available. In some embodiments, the power management determination 114B may be configured to cause gradual ramping up of the AWG system 106 in response to detecting a curtailment condition, so as to avoid sudden transients in the system 101. In some embodiments, the power management determination 114B may be configured to split available power between immediate water generation by the AWG system 106 and charging of the energy storage system 110, for example, when ambient humidity conditions are unfavorable for efficient water extraction. In some embodiments, the power management determination 114B may include or leverage a predictive model, which may be a rule-based model or a machine learning model, configured to generate scheduling determinations for the AWG system 106 based on inputs including weather forecasts and real-time energy availability from the renewable energy system 102. In some embodiments, the power management determination 114B may be configured to prevent overload of components of the system 101 by directing the renewable energy system 102 to curtail generation or directing excess energy to the energy storage system 110 when the AWG system 106 is at maximum capacity.

In some embodiments, the controller 104 may include the environmental sensing determination 114C. In some embodiments, the environmental sensing determination 114C may be configured to detect, measure, and/or collect environmental condition data and operating condition data for one or more systems, subsystems, devices, and/or components of the system 101. In some embodiments, the environmental sensing determination 114C may include or be operably couplable to one or more sensors configured to detect and/or measure environmental condition parameters such as ambient temperature and relative humidity. In some embodiments, the environmental sensing determination 114C may additionally include or be operably couplable to one or more sensors configured to detect and/or measure operating condition parameters associated with the AWG system 106, such as evaporator temperature and/or refrigerant pressure within one or more AWG units. In some embodiments, the controller 104 may be configured to adjust one or more setpoints associated with the AWG system 106 based on data received from the environmental sensing determination 114C, for example, by lowering the target condensing temperature of an AWG unit in response to a detected drop in ambient humidity, or by increasing fan speed in response to a detected high-humidity condition. In some embodiments, the environmental sensing determination 114C may be configured to enable the controller 104 to optimize water generation efficiency of the AWG system 106 under real-time conditions by continuously adjusting one or more operating parameters based on measured environmental and operating condition data.

In some embodiments, the controller 104 may include the safety and maintenance determination 114D. In some embodiments, the safety and maintenance determination 114D may be configured to monitor for, detect, and/or predict faults with one or more systems, subsystems, devices, and/or components of the system 101. In some embodiments, the safety and maintenance determination 114D may be configured to monitor for faults associated with the AWG system 106, such as icing on condensation coils, overpressure in a refrigeration system, or a full water storage condition in the water storage and distribution system 112. In some embodiments, the controller 104 may be configured to perform one or more mitigation actions in response to detecting or predicting a fault, for example, by pausing water production by the AWG system 106 to avoid overflow of the water storage and distribution system 112, or by diverting water to an overflow drainage pathway when non-potable use is available. In some embodiments, the safety and maintenance determination 114D may be configured to facilitate or cause performance of regular automated maintenance cycles for the AWG system 106, including backwashing or cleaning of air filters and circulation of ozone to sanitize water lines. In some embodiments, the safety and maintenance determination 114D may be configured to generate alerts or notifications to operators when a fault condition is detected or predicted, thereby supporting proactive maintenance and reducing unplanned downtime of the system 101.

In some embodiments, the controller 104 may include the grid support determination 114E. In some embodiments, the grid support determination 114E may be configured to provide one or more ancillary services to the electrical grid 108, such as demand response or frequency regulation, by modulating the power consumption of the AWG system 106 in response to grid frequency and/or voltage fluctuations. In some embodiments, the grid support determination 114E may be configured to automatically cause additional power to be drawn by the AWG system 106 in response to a frequency spike associated with the electrical grid 108, which may be indicative of an oversupply condition, thereby reducing the frequency of the spike. In some embodiments, the grid support determination 114E may be configured to cause one or more AWG units of the AWG system 106 to shut off substantially instantaneously in response to a frequency drop associated with the electrical grid 108, which may be indicative of an undersupply condition, thereby shedding load and providing relief to the electrical grid 108. In some embodiments, the grid support determination 114E may be configured to enable the system 101 to serve as an ancillary service device, providing fast demand modulation to the electrical grid 108 that improves overall grid stability. In some embodiments, the grid support determination 114E may be operably couplable to the electrical grid 108 via one or more communication interfaces, including application programming interfaces (APIs), configured to receive grid frequency, voltage, and/or curtailment signals in real time.

In some embodiments, the controller 104 may include the AWG system control 114F. In some embodiments, the AWG system control 114F may be configured to coordinate the routing of energy from the renewable energy system 102 and/or the energy storage system 110 to the AWG system 106, and to regulate the operational state of the AWG system 106 based on the amount of energy available above a predetermined threshold. In some embodiments, the AWG system control 114F may be configured to incrementally activate, ramp up, ramp down, or deactivate individual AWG units of the AWG system 106 in response to changes in the energy output of the renewable energy system 102, so as to match the power consumption of the AWG system 106 to the available curtailed energy. In some embodiments, the AWG system control 114F may be configured to reduce the energy supplied to the AWG system 106 by ramping down one or more AWG units when the available curtailed energy decreases, without requiring a complete power-down of the AWG system 106. In some embodiments, the AWG system control 114F may be operably couplable to the AWG system 106 and to the renewable energy system 102, and may be configured to detect when the renewable energy system 102 is producing an energy output above the predetermined threshold and, in response, direct that excess energy to the AWG system 106 for water generation. In some embodiments, the AWG system control 114F may be configured to coordinate with the power management determination 114B and the curtailment determination 114A to ensure that the AWG system 106 operates primarily on curtailed energy from the renewable energy system 102.

In some embodiments, the controller 104 may include the water storage and distribution control 114G. In some embodiments, the water storage and distribution control 114G may be configured to monitor and coordinate the operation of the water storage and distribution system 112, including the storage of water generated by the AWG system 106 and the release of stored water to the energy generation system 160 and/or to end-use distribution pathways. In some embodiments, the water storage and distribution control 114G may be configured to monitor a level of water stored in the water storage and distribution system 112 and, in response to detecting that the stored water has reached a predetermined threshold level, cause at least a portion of the stored water to be released to the energy generation system 160. In some embodiments, the water storage and distribution control 114G may be configured to regulate the flow rate of water from the water storage and distribution system 112 to the energy generation system 160, so as to control the power output of the energy generation system 160 in response to demand signals received by the controller 104. In some embodiments, the water storage and distribution control 114G may be configured to coordinate the distribution of water from the water storage and distribution system 112 to one or more end uses, such as potable water distribution, agricultural irrigation, or industrial processes, based on demand signals and the current level of water stored in the water storage and distribution system 112. In some embodiments, the water storage and distribution control 114G may be operably couplable to the water storage and distribution system 112 and to the energy generation system 160, and may be configured to communicate signals to one or both of these systems to coordinate the timing and volume of water release.

In some embodiments, the controller 104 may include the energy generation system control 114H. In some embodiments, the energy generation system control 114H may be configured to coordinate the operation of the energy generation system 160, including detecting energy generated by the energy generation system 160 from the gravitational potential energy of water received from the water storage and distribution system 112, and routing that generated energy to one or more of the AWG system 106, the energy storage system 110, the electrical grid 108, or any other coupled system, based on demand signals and current energy availability levels. In some embodiments, the energy generation system control 114H may be configured to cause the water storage and distribution control 114G to release stored water from the water storage and distribution system 112 to the energy generation system 160 when demand for energy is elevated and energy from the renewable energy system 102 and/or the energy storage system 110 is insufficient to meet that demand. In some embodiments, the energy generation system control 114H may be configured to regulate the flow rate of water communicated from the water storage and distribution system 112 to the energy generation system 160, so as to modulate the power output of the energy generation system 160 in response to real-time demand conditions. In some embodiments, the energy generation system control 114H may be operably couplable to the energy generation system 160 and to the water storage and distribution system 112, and may be configured to coordinate between the operation of the AWG system 106 and the operation of the energy generation system 160 to ensure that the system 101 remains water positive over time. In some embodiments, the energy generation system control 114H may be configured to communicate at least a portion of the energy generated by the energy generation system 160 back to the AWG system 106, thereby enabling the system 101 to partially or fully power the AWG system 106 with energy recovered from the gravitational potential energy of the water generated thereby.

FIG. 1C is a schematic block diagram of a system 101c for atmospheric water generation at elevation from ground level G, according to an embodiment. In some embodiments, the system 101c and its components (i.e., the renewable energy system 102c, the AWG system 106c, the water storage and distribution system 112c, the energy storage system 110c, and the energy generation system 160c) may be similar to or substantially the same as the system 101 and its components (i.e., the renewable energy system 102, the AWG system 106, the water storage and distribution system 112, the energy storage system 110, and the energy generation system 160). Accordingly, certain features of the system 101c and/or components thereof (e.g., the renewable energy system 102c, the AWG system 106c, the water storage and distribution system 112c, the energy storage system 110c and the energy generation system 160c) are not described in further detail herein. All such variations are envisioned herein and should be considered as part of the present disclosure.

In some embodiments, the system 101c may include the renewable energy system 102c. In some embodiments, the renewable energy system 102c may include one or more wind turbines 140. In some embodiments, the renewable energy system 102c may include a wind farm including a plurality of wind turbines 140. In some embodiments, the wind turbine 140 may be configured to generate electrical power from wind energy. In some embodiments, the wind turbine 140 may be configured to generate any suitable power output. For example, in some embodiments, the wind turbine 140 may be configured to generate a power output in a range of about 100 kilowatts (kW) to about 20,000 kW, inclusive of all values and ranges therebetween. In some embodiments, the wind turbine 140 may be configured to generate a power output of at least about 100 kW, at least about 250 kW, at least about 500 kW, at least about 750 kW, at least about 1,000 kW, at least about 1,500 kW, at least about 2,000 kW, at least about 2,500 kW, at least about 3,000 kW, at least about 4,000 kW, at least about 5,000 kW, at least about 6,000 kW, at least about 7,000 kW, at least about 8,000 kW, at least about 9,000 kW, at least about 10,000 kW, at least about 12,000 kW, at least about 14,000 kW, at least about 16,000 kW, or at least about 18,000 kW.

In some embodiments, the wind turbine 140 may be configured to generate a power output of no more than about 20,000 kW, no more than about 18,000 kW, no more than about 16,000 kW, no more than about 14,000 kW, no more than about 12,000 kW, no more than about 10,000 kW, no more than about 9,000 kW, no more than about 8,000 kW, no more than about 7,000 kW, no more than about 6,000 kW, no more than about 5,000 kW, no more than about 4,000 kW, no more than about 3,000 kW, no more than about 2,500 kW, no more than about 2,000 kW, no more than about 1,500 kW, no more than about 1,000 kW, no more than about 750 kW, no more than about 500 kW, or no more than about 250 kW. Combinations of the above-referenced power outputs are also possible (e.g., at least about 100 kW and no more than about 20,000 kW, or at least about 1,000 kW and no more than about 5,000 kW), inclusive of all values and ranges therebetween. All such variations are envisioned herein and should be considered as part of the present disclosure.

In some embodiments, the wind turbine 140 may have any suitable hub height. For example, in some embodiments, the wind turbine 140 may have a hub height in a range of about 40 meters to about 200 meters, inclusive of all values and ranges therebetween. For example, in some embodiments, the wind turbine 140 may have a hub height of at least about 40 meters, at least about 50 meters, at least about 60 meters, at least about 70 meters, at least about 80 meters, at least about 90 meters, at least about 100 meters, at least about 110 meters, at least about 120 meters, at least about 130 meters, at least about 140 meters, at least about 150 meters, at least about 160 meters, at least about 170 meters, or at least about 180 meters. In some embodiments, the wind turbine 140 may have a hub height of no more than about 200 meters, no more than about 180 meters, no more than about 170 meters, no more than about 160 meters, no more than about 150 meters, no more than about 140 meters, no more than about 130 meters, no more than about 120 meters, no more than about 110 meters, no more than about 100 meters, no more than about 90 meters, no more than about 80 meters, no more than about 70 meters, no more than about 60 meters, or no more than about 50 meters. Combinations of the above-referenced hub heights are also possible (e.g., at least about 40 meters and no more than about 200 meters, or at least about 80 meters and no more than about 150 meters), inclusive of all values and ranges therebetween. All such variations are envisioned herein and should be considered as part of the present disclosure.

In some embodiments, the renewable energy system 102c may include any suitable number of wind turbines 140. For example, in some embodiments, the renewable energy system 102c may include at least about 1 wind turbine, at least about 2 wind turbines, at least about 5 wind turbines, at least about 10 wind turbines, at least about 20 wind turbines, at least about 30 wind turbines, at least about 40 wind turbines, at least about 50 wind turbines, at least about 75 wind turbines, at least about 100 wind turbines, at least about 150 wind turbines, at least about 200 wind turbines, at least about 250 wind turbines, at least about 300 wind turbines, at least about 350 wind turbines, or at least about 400 wind turbines. In some embodiments, the renewable energy system 102c may include no more than about 500 wind turbines, no more than about 400 wind turbines, no more than about 350 wind turbines, no more than about 300 wind turbines, no more than about 250 wind turbines, no more than about 200 wind turbines, no more than about 150 wind turbines, no more than about 100 wind turbines, no more than about 75 wind turbines, no more than about 50 wind turbines, no more than about 40 wind turbines, no more than about 30 wind turbines, no more than about 20 wind turbines, no more than about 10 wind turbines, no more than about 5 wind turbines, or no more than about 2 wind turbines. Combinations of the above-referenced numbers of wind turbines 140 are also possible (e.g., at least about 1 wind turbine and no more than about 500 wind turbines, or at least about 10 wind turbines and no more than about 100 wind turbines), inclusive of all values and ranges therebetween. All such variations are envisioned herein and should be considered as part of the present disclosure.

In some embodiments, the renewable energy system 102c may include a substation 128c. In some embodiments, the substation 128c may be operably couplable to one or more wind turbines 140 and may be configured to receive power 130 generated by the wind turbines 140. In some embodiments, the substation 128c may be configured to communicate power 130 to the electrical grid 108 and/or to the AWG system 106c. In some embodiments, the substation 128c may be configured to step up or step down the voltage of the power 130 generated by the wind turbines 140 to a voltage suitable for transmission to the electrical grid 108 or for use by the AWG system 106c.

In some embodiments, the system 101c may include the AWG system 106c. In some embodiments, the AWG system 106c may include one or more atmospheric water generators 200c (also referred to herein as AWG apparatus, AWG modules, or AWG units). In some embodiments, the AWG system 106c may be configured to draw in ambient air (e.g., humid air 132) and extract moisture from the ambient air to produce liquid water 136 (e.g., potable water). In some embodiments, the AWG system 106c may be configured to discharge dry air 134 as a byproduct of the water extraction process. In some embodiments, the AWG system 106c may be configured to receive power 130 from the renewable energy system 102c and/or the energy storage system 110c and to use that power 130 to drive the water extraction process. In some embodiments, the AWG system 106c may be configured to operate primarily using curtailed power 130 from the renewable energy system 102c, that is, power 130 generated by the wind turbines 140 in excess of what is demanded by the electrical grid 108, a local load, or other coupled systems. In some embodiments, the AWG system 106c may include a plurality of modular AWG units 200c, each of which may be independently activated, deactivated, ramped up, or ramped down by the controller 104c based on the amount of curtailed power 130 available from the renewable energy system 102c and/or the energy storage system 110c.

In some embodiments, the AWG system 106c may include one or more atmospheric water generators 200c (also referred to herein as AWG apparatus, AWG modules, or AWG units) configured to generate water from ambient air. In some embodiments, the AWG system 106c may include a plurality of modular AWG units 200c, each of which may be independently activated, deactivated, ramped up, or ramped down by the controller 104c based on the amount of curtailed energy available from the renewable energy system 102c and/or the energy storage system 110c. In some embodiments, the water output of each AWG unit 200c may be collected into a common water storage unit 138c.

In some embodiments, each individual AWG unit 200c may be configured to produce water from ambient air at any suitable production rate. In some embodiments, each individual AWG 200c may be configured to produce water at a rate of about 50 liters per day to about 50,000 liters per day, inclusive of all values and ranges therebetween. For example, in some embodiments, each AWG unit 200c may be configured to produce water from ambient air at a rate of at least about 50 liters per day, at least about 100 liters per day, at least about 250 liters per day, at least about 500 liters per day, at least about 1,000 liters per day, at least about 2,500 liters per day, at least about 5,000 liters per day, at least about 7,500 liters per day, at least about 10,000 liters per day, at least about 15,000 liters per day, at least about 20,000 liters per day, at least about 25,000 liters per day, at least about 30,000 liters per day, at least about 35,000 liters per day, at least about 40,000 liters per day, or at least about 45,000 liters per day. In some embodiments, each AWG 200c may be configured to produce water from ambient air at a rate of no more than about 50,000 liters per day, no more than about 45,000 liters per day, no more than about 40,000 liters per day, no more than about 35,000 liters per day, no more than about 30,000 liters per day, no more than about 25,000 liters per day, no more than about 20,000 liters per day, no more than about 15,000 liters per day, no more than about 10,000 liters per day, no more than about 7,500 liters per day, no more than about 5,000 liters per day, no more than about 2,500 liters per day, no more than about 1,000 liters per day, no more than about 500 liters per day, no more than about 250 liters per day, no more than about 100 liters per day, or no more than about 50 liters per day. Combinations of the above-referenced per-unit water production rates are also possible (e.g., at least about 50 liters per day and no more than about 50,000 liters per day, or at least about 500 liters per day and no more than about 10,000 liters per day), inclusive of all values and ranges therebetween. All such variations are envisioned herein and should be considered as part of the present disclosure.

In some embodiments, each AWG 200c may include an air handling system (e.g., fans, blowers, ducting, and/or the like), a moisture extraction system (e.g., which may be implemented as a refrigeration cycle or desiccant cycle as further described herein), a water collection and purification system (e.g., filters, UV sterilizer or ozonation, mineralization cartridge, for example, if needed for drinking water), and/or water storage tank(s). In some embodiments, each AWG 200c may include air intake fan(s), air filter(s), refrigeration compressor(s), cooling condensation unit(s), heat exchangers (e.g., evaporator and condenser coils or desiccant contactors), water collection and purification modules, and/or storage tank(s).

As further described herein with reference to FIGS. 2A-2G, in some embodiments, each AWG 200c may be configured to employ one or more techniques (e.g., cooling condensation techniques, sorption techniques, and/or other techniques) to capture water vapor and condense it into water. In some embodiments, the AWG 200 may be configured to cool air (e.g., humid air 132) below its dew point to condense water. For example, in some embodiments, the one or more AWGs 200c may include a cooling/condensation cycle.

In some embodiments, the one or more AWGs 200c may be configured to absorb water vapor using desiccant materials. For example, in some embodiments, the one or more AWGs 200c may include a desiccant-based absorption and regeneration cycle. In some embodiments, the one or more AWGs 200c may include a hybrid AWG configured to use both a cooling condensation technique and a desiccant (sorption) technique, individually or in parallel, to capture water vapor and condense it into water.

In some embodiments, the system 101c may include the water storage and distribution system 112c. In some embodiments, the water storage and distribution system 112c may include a water storage unit 138c. In some embodiments, the water storage unit 138c may include a water tank, a reservoir, a basin, a dam, a cistern, or any other suitable water storage vessel or structure. In some embodiments, the water storage unit 138c may be configured to receive and store at least a portion of the water 136 generated by the AWG system 106c. In some embodiments, the water storage and distribution system 112c may be configured to release at least a portion of the water 136 stored in the water storage unit 138c to the energy generation system 160c. For example, in some embodiments, the water storage unit 138 may be configured to communicate at least a portion of the water 136 stored therein to the energy generation system 160c in response to a signal from the controller 104. In some embodiments, the water storage and distribution system 112c may be configured to deliver stored water 136 for end use, such as for potable water distribution, agricultural irrigation, industrial processes, or any other suitable end use.

In some embodiments, the system 101c may include the energy generation system 160c. In some embodiments, the energy generation system 160c may be configured to receive at least a portion of the water 136 stored in the water storage unit 138 and convert the gravitational potential energy of the received water 136 into one or more forms of useable energy. In some embodiments, the energy generation system 160c may include an energy storage system 162. In some embodiments, the energy storage system 162 may be configured to store at least a portion of the energy generated by the energy generation system 160c, for example when the generated energy is not immediately consumed or dispatched. In some embodiments, the energy storage system 162 may include one or more batteries, capacitors, supercapacitors, flywheels, compressed air storage units, or any other suitable energy storage device or system. In some embodiments, the energy generation system 160c may be configured to communicate at least a portion of the converted energy to at least one of the AWG system 106c, the energy storage system 110c, the electrical grid 108, or any other coupled system or load.

In some embodiments, the energy generation system 160c may be configured to receive at least a portion of the stored water 136 from the water storage and distribution system 112c and convert the gravitational potential energy of the received water 136 into one or more forms of useable energy. In some embodiments, the energy generation system 160c may include an energy storage system 162c. In some embodiments, the energy storage system 162c may be configured to store at least a portion of the energy generated by the energy generation system 160c from the potential energy of the water received from the water storage and distribution system 112c, for example when the generated energy is not immediately consumed or dispatched. In some embodiments, the energy storage system 162c may include one or more batteries, capacitors, supercapacitors, flywheels, compressed air storage units, or any other suitable energy storage device or system. In some embodiments, the energy storage system 162c may be configured to supply stored energy to the energy generation system 160c or to another coupled system, such as the AWG system 106c, the energy storage system 110c, or the electrical grid 108.

In some embodiments, the AWG system 106c and the water storage and distribution system 112c, including the water storage unit 138, may be located at the first and/or second elevation (i.e., H1/H2), for example, measured from ground level G. In some embodiments, the AWG system 106c may be located at the first elevation H1 and the water storage and distribution system 112c may also be located at the first elevation H1. In some embodiments, the AWG system 106c may be located at the first elevation H1 and the water storage and distribution system 112c may be located at second first elevation H2 that is lower than the first elevation H1. In some embodiments, the energy generation system 160c, including the energy storage system 162c, may be located at a third elevation H3. In some embodiments, H1/H2 may be higher than H3, such that H1/H2 corresponds to the first elevation and/or the second elevation as described herein with respect to the system 101, and H3 corresponds to the third elevation as described herein with respect to the system 101. In other words, the third elevation H3 is lower than first elevation H1 and the second elevation H2, such that the water stored by the water storage and distribution system 112c is at a higher elevation relative to the energy generation system 160c and carries potential energy relative to the third elevation H3. In some embodiments, water 136 generated by the AWG system 106c and stored in the water storage unit 138 at the higher elevation H1/H2 may be communicated downward to the energy generation system 160c at the lower elevation H3, and the gravitational potential energy released by the communicating water 136 may be converted into useable energy by the energy generation system 160c.

FIG. 1D is a schematic block diagram of a system 101d for atmospheric water generation at elevation using solar photovoltaic energy, according to an embodiment. In some embodiments, the system 101d and its components (i.e., the renewable energy system 102d, the AWG system 106d, the water storage and distribution system 112d, the energy storage system 110d, and the energy generation system 160d) may be similar to or substantially the same as the system 101 and its components (i.e., the renewable energy system 102, the AWG system 106, the water storage and distribution system 112, the energy storage system 110, and the energy generation system 160). Accordingly, certain features of the system 101d and/or components thereof (e.g., the renewable energy system 102d, the AWG system 106d, the water storage and distribution system 112d, the energy storage system 110d, and the energy generation system 160d) are not described in further detail herein. All such variations are envisioned herein and should be considered as part of the present disclosure.

In some embodiments, the system 101d and its components (i.e., the renewable energy system 102d, the AWG system 106d, the water storage and distribution system 112d, the energy storage system 110d, and the energy generation system 160d) may be similar to or substantially the same as the system 101c and its components (i.e., the renewable energy system 102c, the AWG system 106c, the water storage and distribution system 112c, the energy storage system 110c, and the energy generation system 160c). Accordingly, certain features of the system 101d and/or components thereof (e.g., the renewable energy system 102d, the AWG system 106d, the water storage and distribution system 112d, the energy storage system 110d, and the energy generation system 160d) are not described in further detail herein. All such variations are envisioned herein and should be considered as part of the present disclosure.

In some embodiments, the system 101d may include the renewable energy system 102d. In some embodiments, the renewable energy system 102d may include one or more solar panels 142. In some embodiments, the renewable energy system 102d may include a solar photovoltaic array including a plurality of solar panels 142. In some embodiments, the solar panels 142 may be configured to generate electrical power from solar irradiance. In some embodiments, each solar panel 142 or solar panel array may be operably couplable to a substation 128 and may be configured to supply power 130 to the electrical grid 108 and/or to one or more AWG units 200d of the AWG system 106d. In some embodiments, the solar panels 142 may be configured to generate any suitable power output. In some embodiments, the renewable energy system 102d may include any suitable number of solar panels 142 or solar panel arrays. In some embodiments, the renewable energy system 102d may include a combination of one or more solar panels 142 and one or more wind turbines 140. In some embodiments, the renewable energy system 102d may include any other suitable renewable energy source or combination of renewable energy sources.

In some embodiments, the system 101d may include the AWG system 106d. In some embodiments, the AWG system 106d may include one or more atmospheric water generators 200d configured to generate water from ambient air. In some embodiments, the AWG system 106d may be configured to receive power 130 from the renewable energy system 102d and/or the energy storage system 110d and to use that power 130 to drive the water extraction process. In some embodiments, the AWG system 106d may be configured to operate primarily using curtailed power 130 from the renewable energy system 102d, that is, power 130 generated by the solar panels 142 in excess of what is demanded by the electrical grid 108, a local load, or other coupled systems. In some embodiments, the AWG system 106d may include a plurality of modular AWG units 200d, each of which may be independently activated, deactivated, ramped up, or ramped down by the controller 104 based on the amount of curtailed power 130 available from the renewable energy system 102d and/or the energy storage system 110d. In some embodiments, the AWG system 106d and the water storage and distribution system 112d, including the water storage unit 138d, may be located at the first and/or second elevation (i.e., H1/H2), for example, relative to ground level G. In some embodiments, the energy generation system 160d, including the energy storage system 162d thereof, may be located at a third elevation H3. In some embodiments, H1/H2 may be greater than H3, such that H1/H2 corresponds to the first elevation and/or the second elevation as described herein with respect to the system 101, and H3 corresponds to the third elevation as described herein with respect to the system 101. In some embodiments, water 136 generated by the AWG system 106d and stored in the water storage unit 138d at the higher elevation H1/H2 may be communicated downward to the energy generation system 160d at the lower elevation H3, and the gravitational potential energy released by the communicating water 136 may be converted into useable energy by the energy generation system 160d.

In some embodiments, the system 101d may include the energy storage system 110d. In some embodiments, the energy storage system 110d may include one or more of a thermal storage unit 144, a battery bank 146, and/or a mechanical storage unit 148. In some embodiments, the thermal storage unit 144 may include a phase-change material and/or a chilled fluid that stores cooling energy when surplus power from the solar panels 142 runs the refrigeration components of the AWG units 200d at or above a threshold capacity, and thereafter provides cooling capacity to continue condensing water without using additional electrical input from the renewable energy system 102d. In some embodiments, the thermal storage unit 144 may be implemented as a thermal ice-storage tank. In some embodiments, the battery bank 146 may include one or more batteries configured to store electrical energy from the renewable energy system 102d. In some embodiments, the battery bank 146 may be configured to store surplus electrical energy generated by the solar panels 142 during periods of peak solar irradiance and to supply that stored energy to the AWG system 106d during periods of low or no solar irradiance, such as nighttime hours, thereby enabling continuous water generation at elevation H1/H2 even when the renewable energy system 102d is not actively generating power. In some embodiments, the mechanical storage unit 148 may include a flywheel, a compressed air tank, and/or other mechanical storage devices configured to store and release energy as needed to support the operation of the AWG system 106d. In some embodiments, the controller 104d may be configured to coordinate the operation of the energy storage system 110d and the AWG system 106d to maximize the utilization of available curtailed energy from the renewable energy system 102d and the production of water at elevation H1/H2. In some embodiments, water 136 stored in the water storage unit 138d at elevation H1/H2 may be communicated to the energy generation system 160d at elevation H3 to convert the gravitational potential energy of the water 136 into useable energy.

FIGS. 2A-2B are schematic diagrams of atmospheric water generators, according to various embodiments.

The depiction of an example AWG 200 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIGS. 2A-B and the example AWG 200 disclosed therein are merely presented to provide an example for the facilitation of some of the potential features, aspects, and uses of some embodiments of the methods, apparatuses, and systems disclosed and contemplated herein.

In some embodiments, the process of atmospheric water generation may include extracting water vapor from an atmospheric source air (e.g., ambient air/humid air) at least in part by condensing the water vapor and capturing the condensed, liquid water (e.g., by absorbing the liquid water into a desiccant solution). In some embodiments, the AWG 200 may be configured to employ various techniques to extract atmospheric moisture, enabling operation in diverse climates. For example, in some embodiments, the AWG 200 may be configured to extract and condense water vapor from an ambient air via at least one of a cooling-condensation atmospheric water generation technique or a desiccant-based atmospheric water generation technique.

In some embodiments, the AWG 200 may be configured to perform various operations for preconditioning and/or compressing raw source air (e.g., air at atmospheric conditions) to ease the water extraction process, and/or condensing the water vapor trapped within the raw source air (e.g., by increasing the humidity of at least a portion of the raw source air) to maximize the amount of water vapor that may be extracted from a given unit volume of source air.

In some embodiments, the AWG 200 may be configured to utilize condensation mechanisms through which source air (e.g., raw source air and/or processed source air, as discussed herein) may be directed over one or more condensation surfaces each having a surface temperature below the dew point of the source air. Without wishing to be bound by theory, in some embodiments, as the source air flows over and/or around the condensation surfaces of the AWG 200, a temperature of the source air adjacent the condensation surfaces may drop (e.g., through convective heat transfer), and water vapor within the source air may condense on the condensation surfaces, and the condensed, liquid water may flow into a storage vessel (e.g., a capture tank) and/or to one or more related modules (e.g., a greenhouse module) for immediate use.

In some embodiments, the AWG 200 may be configured to precondition the raw source air, for example, to ease the water extraction process utilized to condense water vapor into usable liquid water. In some embodiments, the AWG 200 may be configured to perform a preconditioning process. In some embodiments the preconditioning process may include compressing the air to increase the vapor pressure of the air (thereby biasing a greater volume of water to the liquid state rather than the vapor state) and/or to decrease the temperature of the source air to a temperature nearer to the dew point. In some embodiments, the AWG 200 may include at least one of a humidity increasing system or an air preconditioning system that may be configured to be utilized before and/or after the humidity increasing system, (e.g., a desiccant-based humidity increasing system as described herein). Moreover, in some embodiments, the AWG 200 may include at least one of a carbon dioxide capture system or the air preconditioning system which may be configured to be utilized before and/or after the carbon dioxide capture system.

In some embodiments, the AWG 200 may include a series of compressors/pumps, venturi valves, vortex valves, manifolds, and/or the like collectively configured to decrease the temperature of the source air closer to the air dew point and/or to increase the pressure of the air prior to removing water vapor from the air (e.g., through condensation or absorption by a desiccant). For example, in some embodiments, the AWG 200 may include a compressor (e.g., a turbine/blower compressor having a plurality of stator or variable pitch turbine blades controllable via servo motors) configured to draw in the raw source air via a vacuum pressure formed at an inlet of the AWG 200 and/or a centrifugal fan configured to increase the raw air pressure entering the AWG 200. In some embodiments, the AWG 200 may include a fan configured to rotate at least one of the compressor or the centrifugal via one or more electrical motors (which may receive electrical input power from one or more power systems in communication with the AWG 200). In some embodiments, the AWG 200 and/or components thereof (e.g., the compressor and/or the centrifugal fan) may be mechanically couplable with the one or more power systems via a gear transmission, a belt drive, a chain drive, and/or any other suitable mechanical coupling.

In some embodiments, the AWG 200 may include the centrifugal fan configured to spin particulates (e.g., dust and/or other heavy air contaminants) to an outermost edge of the centrifugal fan to remove the particulates from the air stream and ejected them from the AWG 200 and/or from one or more components thereof. In some embodiments, the AWG 200 may include a carbon dioxide capture column. In some embodiments, the AWG 200 and/or one or more components thereof may be configured to direct the filtered air into the carbon dioxide capture column. For example, in some embodiments, the AWG 200 may be configured to direct the filtered air into the carbon dioxide capture column wherein the filtered air may pass over a fixed absorption bed configured to absorb carbon dioxide from the air. In some embodiments, the AWG 200 may include a carbon dioxide capture system. In some embodiments, the AWG 200 and/or one or more components thereof may be configured to pass air (e.g., the filtered air) through the carbon dioxide capture system including the carbon dioxide capture column having a fixed bed of a carbon dioxide absorbing material (e.g., a sodium hydroxide solution in some embodiments).

In some embodiments, the AWG 200 and or one or more components thereof (e.g., the carbon dioxide absorbing material) may be configured to absorb carbon dioxide from the filtered air passed thereover. In some embodiments, the AWG 200 and/or one or more components thereof may be configured to heat the carbon dioxide capture column (e.g., via a hot fluid jacket) to facilitate increased carbon dioxide absorption by the carbon dioxide absorbing material. In some embodiments, the AWG 200 and/or one or more components thereof (e.g., the carbon dioxide capture material) may be configured to reversibly absorb carbon dioxide from the filtered air, such that the captured carbon dioxide may be compressed and stored as a gas for later use.

In some embodiments, the AWG 200 may include a fixed absorption bed configured to absorb carbon dioxide from an air stream passed thereover. For example, in some embodiments, the AWG 200 and/or one or more components thereof may be configured to utilize a sorption process to remove water vapor from the air stream before directing the post-sorption air into the carbon dioxide capture column, where the post-sorption air may be passed over the fixed absorption bed to absorb carbon dioxide from the air. In some embodiments, the AWG 200 and/or one or more components thereof may be configured to separate the carbon dioxide and direct the carbon dioxide away from the air stream via a compressor. In some embodiments, the AWG 200 may include an air preconditioning system having a primary manifold. For example, in some embodiments, the AWG 200 and/or one or more components thereof may be configured to direct the filtered air (i.e., the filtered air with a reduced carbon dioxide content) through the air preconditioning system into the primary manifold. In some embodiments, the AWG 200 and/or one or more components thereof (e.g., the primary manifold) may be configured to divide the air at a predetermined ratio via a variable plenum/valve. In some embodiments, the AWG 200 may include a vortex tube manifold. For example, in some embodiments, the AWG 200 and/or one or more components thereof may be configured to direct a first air stream of the separated air along a bulk air stream, and direct a second air stream of the separated air to a vortex tube manifold.

In some embodiments, the AWG 200 may include one or more venturi valves. For example, in some embodiments, the AWG 200 and/or one or more components thereof (e.g., the one or more venturi valves) may be configured to decrease at least one of a pressure or a temperature of the bulk air stream. Without wishing to be bound by theory, in some embodiments, the volume and quantity of air may remain constant across each of the one or more venturi valves while the pressure decreases such that the temperature of the air stream may decrease proportionally to the temperature. In some embodiments, the AWG 200 may include a precooler (e.g., a heat exchanger including a heat exchange medium flowing therethrough. For example, in some embodiments, the AWG 200 and/or one or more components thereof (e.g., the precooler) may be configured to decrease a pressure and/or a temperate of the bulk air stream.

In some embodiments, the AWG 200 may include a temperate measurement portion. For example, in some embodiments, the AWG 200 and/or one or more components thereof (e.g., the temperature measurement portion) may be configured to measure a temperature (e.g., a dry bulb temperature and/or a wet bulb temperature) of the bulk air stream (i.e., the reduced pressure and temperature bulk air stream) via one or more temperature measurement devices (e.g., thermometers). In some embodiments, the AWG 200 and/or one or more components thereof may be configured to determine a dew point of the bulk air stream based on the measured temperatures.

In some embodiments, the AWG 200 may include a controller. In some embodiments, the AWG 200 and/or one or more components thereof (e.g., the controller) may be configured to receive outputs from the temperature measurement devices and mix the bulk air stream with at least a portion of the vortex-chilled air stream to lower the temperature of the bulk air closer to the air dew point. In some embodiments, the AWG 200 may include an electromechanical mixing valve. In some embodiments, the controller may be in electronic communication with the electromechanical mixing valve, and the electromechanical mixing valve may be selectively opened or closed to vary the amount of vortex-chilled air that is introduced into the bulk air stream. In some embodiments, based on the determined dry-bulb and/or wet-bulb temperatures (as monitored by the controller), the controller may be configured to transmit a signal to a motor to move the electromechanical valve to a desired position to obtain a desired mixture of vortex-chilled air with the bulk air stream.

In some embodiments, the AWG 200 may include a vortex tube manifold having one or more vortex tubes. In some embodiments, the vortex-chilled air may begin as the second stream of air exiting the primary manifold. In some embodiments, the AWG 200 and/or one or more components thereof (e.g., the vortex tube manifold) may be configured to receive the second stream of air from the primary manifold and pressurize the second stream of air (e.g., via a compressor) to a sufficient pressure to achieve a drop in temperature of the air travelling through the one or more vortex tubes of between approximately 70-150 degrees Fahrenheit. For example, in some embodiments, the AWG 200 and/or one or more components thereof may be configured to pressurize the air to at least approximately 70-120 psi prior to directing the air into the one or more vortex tubes. In some embodiments, each vortex tube may include an entry port configured to direct the stream of air tangentially into an internal spin chamber. In some embodiments, as air enters the spin chamber, the air may take on an angular momentum, causing dense, warm air to migrate towards an exterior perimeter of the spin chamber and out of an exhaust valve. In some embodiments, the AWG 200 and/or one or more components thereof may be configured to utilize the warm air to heat a carbon dioxide capture column. In some embodiments, the remaining, vortex-chilled air may migrate toward the center of the spin chamber and out of a vortex outlet. In some embodiments, the AWG 200 and/or one or more components thereof may be configured to mix the vortex-chilled air with the bulk air stream to lower the temperature of the bulk air stream closer to the dew point. In some embodiments, the AWG 200 and/or one or more components thereof may be configured to utilize the vortex-chilled air to chill the precooler through which the bulk air passes.

In some embodiments, the AWG 200 may include a condensation chamber. In some embodiments, the AWG 200 and/or one or more components thereof (e.g., the condensation chamber) may be configured to receive the mixed and chilled bulk air stream and condense the water vapor within the air into liquid water. For example, in some embodiments, the AWG 200 and/or one or more components thereof may be configured to direct the bulk air stream over a series of condensation surfaces (e.g., chilled plates, screens, tubes, and/or the like) configured to lower the localized temperature of the air at the condensation surfaces below the air dew point, thereby causing the water vapor to condense on the condensation surfaces. In some embodiments, the AWG 200 may include a retention chamber. In some embodiments, the AWG 200 and/or one or more components thereof may be configured to route the condensed water from the condensation surfaces into the retention chamber for collection and later use. However, it should be understood that any of a variety of condensation mechanisms may be used. For example, in some embodiments, the AWG 200 and/or one or more components thereof may be configured to utilize one or more desiccant-based condensation mechanisms to remove water vapor from the bulk air stream. Moreover, in some embodiments, the air-preconditioning system may be omitted, and the AWG 200 and/or one or more components thereof may be configured to filter and/or direct raw air immediately into a condensation chamber of the AWG 200. In some embodiments the AWG 200 and/or one or more components thereof may have a lower input power requirement relative to other embodiments, and therefore the amount of power required for water generation may be decreased.

In some embodiments, the AWG 200 may include a preconditioning system including one or more filters (e.g., fabric-based air filters, non-woven based air filters, and/or the like), one or more refrigerant systems (e.g., configured to pass warm air through a heat-exchanger to lower the temperature of the air closer to the dew point), and/or the like in place of or in addition to the vortex and venturi valve mechanisms discussed herein.

In some embodiments, the AWG 200 may include one or more subsystems configured to increase the humidity of a portion of the source air to increase the amount of water that may be extracted from the source air. For example, in some embodiments, the AWG 200 and/or one or more components thereof may be configured to extract water vapor from a first, large quantity of source air, and reintroduce the extracted water vapor into a second, smaller quantity of source air, thereby consolidating the water vapor of the source air and increasing the humidity of the second quantity of source air before the water vapor in the second quantity of source air is condensed into liquid water.

In some embodiments, the AWG 200 may include at least one air scrubber having a column for contacting atmospheric air (e.g., after increasing the humidity of the air) with a desiccant. In some embodiments, the desiccant solution may include a fluid, a gel, and/or any other suitable desiccant solution. In some embodiments, the desiccant may include at least one ionic solutions capable of absorbing water. For example, in some embodiments, the desiccant may include at least one of: lithium-chloride (LiCl), lithium-bromide (LiBr), calcium chloride (CaCl), triethylene glycol, potassium formate, potassium acetate, magnesium chloride, zinc chloride, cesium formate, triethylene glycol, choline based ionic liquids, or any other suitable ionic solution. In some embodiments, the desiccant may include at least one of a diethanolamine ammonium based ionic liquid (e.g., 1-ethyl-3-methylimidazolium acetate, 1-butyl-3-methylimidazolium chloride, or 1-ethyl-3-methylimidazolium chloride). In some embodiments, the desiccant may include other chemical compounds having hygroscopic characteristics. In some embodiments, the hygroscopic fluid may also include at least one of a surfactant or a nanofluid. In some embodiments, the desiccant solution may include a mixture of a plurality of ionic solutions. For example, in some embodiments, the desiccant solution may include a mixture of LiCl solution and CaCl solution. In some embodiments, the AWG 200 may include at least one desiccant column. In some embodiments, the desiccant may include a highly concentrated desiccant aqueous solution that may be configured to be pumped (e.g., via liquid pumps) through the at least one desiccant column. In some embodiments, the desiccant may include other materials (e.g., gels, aerogels, desiccant granules).

In some embodiments, the AWG 200 may include a closed-system including the desiccant. Without wishing to be bound by theory, in some embodiments, the desiccant may be configured to absorb an amount of water vapor based on the vapor pressure and temperature of the closed system including the desiccant. Accordingly, in some embodiments, the AWG 200 and/or one or more components thereof may be configured to absorb water from the air into the desiccant while the vapor pressure in the closed system is above a predetermined vapor pressure threshold and the temperature in the closed system is below a predetermined temperature threshold. In some embodiments, the AWG 200 and/or one or more components thereof may be configured to extract water from the desiccant while the vapor pressure in the closed system is below a predetermined vapor pressure threshold, and the temperature is above a predetermined temperature threshold.

In some embodiments, the AWG 200 may include one or more absorption modules. In some embodiments, the AWG 200 and/or one or more components thereof (e.g., the one or more absorption modules) may be configured to extract water from air. In some embodiments, the AWG 200 may include a single absorption module or multiple absorption modules. In some embodiments, the absorption modules may be connected with additional modules within the AWG 200, including the water extraction module(s) discussed in greater detail below, such that the desiccant can flow between the water absorption module and the additional modules of the AWG 200. In some embodiments, flow paths to and from the absorption modules within the overall AWG 200 may be configurable (e.g., configurable via valves between open and closed configurations), such that the absorption modules can operate as closed-modules in a batch-operating mode (with the desiccant flowing only within the absorption module and/or between multiple absorption modules) prior to passing the desiccant to water extraction modules. In some embodiments (e.g., when valves are in an open configuration, or in embodiments without valves), the desiccant may flow freely between the absorption module(s) and the water extraction module(s), such as in a continuous flow operating configuration.

Moreover, in some embodiments, air entering the absorption module(s) (e.g., via air flow path 201 entering absorber 210 and exiting absorber as dry air via flow path 202-204 shown in FIG. 2A) may flow from a pre-conditioning module configured for increasing the humidity of atmospheric air prior to extracting water from the atmospheric air within the absorber 210. In some embodiments, the AWG 200 and/or one or more components thereof may be configured to direct air directly into the absorption module(s) from the surrounding atmosphere external to the AWG 200.

In some embodiments, the AWG 200 may include an absorption module including an absorber 210 configured to contact ambient/atmospheric air (e.g., after preconditioning) with a desiccant (flowing through the absorber 210 along flow paths 221-222) so as to absorb water from the atmospheric air into the desiccant. In some embodiments, the absorber 210 may include a vessel in which the desiccant flows between an inlet (via flow path 221) and an outlet (via flow path 222), and the ambient/atmospheric air flows between an air inlet (air flow path 201) and an air outlet (flow path 202-204, inclusive of blower 203). In some embodiments, within the vessel, the ambient air may contact the desiccant to enable mass transfer of water vapor from the ambient air into the desiccant. In some embodiments, the AWG 200 may include one or more baffles, flow interrupters, packings (e.g., structured packing or random packing) placed within the absorber 210 to increase the surface area of the desiccant and/or to increase the contact time between the ambient air and the desiccant.

In some embodiments, the AWG 200 may include the absorber 210 arrange in a counter flow configuration where atmospheric air enters the absorber 210 proximate to the bottom of the absorber 210. In some embodiments, the AWG 200 and/or one or more components thereof (e.g., the absorber 210) may be configured to exhaust dry, atmospheric air from the absorber 210 proximate the top of the absorber 210 via a specific flow path (via a pump/blower 203 utilized to move air through the absorber 210). In some embodiments, rich desiccant (e.g., a desiccant fluid) may enter proximate the top of the absorber 210 via an inlet flow path 221 and flow down through the interior of the absorber 210 due to gravity. In some embodiments, the AWG 200 and/or one or more components thereof (e.g., the absorber 210) may be configured such that water is absorbed from the ambient air into the desiccant, such that dilute desiccant exits the absorber proximate to the bottom of the absorber 210 along an outlet flow path 222. In some embodiments, the AWG 200 may include flow modifiers, such as barriers, mesh, packing components, and/or turns in exit piping from the absorber 210 configured to reduce carry over of desiccant in the air exit of the absorber 210. In some embodiments, the flow modifiers may be positioned in the interior of the absorber 210 proximate to the top of the absorber 210 (e.g., at a mouth of an exhaust port for dry ambient air to exit the absorber via an exhaust air flow path).

In some embodiments, the AWG 200 may include the absorber 210 configured to operate in a cross-flow configuration where air enters the absorber from one side of the absorber 210 and traverses (e.g., at least substantially horizontally) to the other side. In some embodiments, rich desiccant (e.g., desiccant fluid) may enter the top of the absorber 210, absorb water from the ambient air as it flows to a low point in the absorber 210 where dilute desiccant exits proximate the bottom. For example, in some embodiments, the air flow may be at least substantially perpendicular to the flow of desiccant within the absorber 210. In some embodiments, in this configuration, the air inlet and air outlet may be approximately at the same height on the absorber 210.

In some embodiments, the AWG 200 may include the absorber 210 configured to operate in a cross-counter flow configuration where air enters the absorber 210 from one side of the absorber 210 and traverses to the other side. In some embodiments, rich desiccant (e.g., desiccant fluid) may enter proximate the top of the absorber 210 and absorb water from the ambient air as it flows to a low point in the absorber 210 where dilute desiccant exits proximate the bottom of the absorber 210. In some embodiments, in this configuration, the air inlet and air outlet may be offset in level from each other. In some embodiments, the air inlet may be at the side of the absorber 210 at a location proximate to the top of the absorber 210 and the air outlet may be on the side of the absorber 210 proximate to the bottom. In some embodiments, in another orientation of this configuration, the air inlet may be positioned on the side of the absorber 210 proximate to the bottom of the absorber 210 and the air outlet may be positioned on the opposite side of the absorber 210 proximate to the top of the absorber 210. In some embodiments, the air may travel along a path extending at an angle through the absorber 210 from the top of the absorber 210 to the bottom or the bottom of the absorber 210 to the top.

In some embodiments, the AWG 200 may include a plurality of packing components disposed within the interior of the absorber 210, around which the rich desiccant may flow as it absorbs water extracted from the humid ambient air. In some embodiments, the packing components may be configured to increase the surface area of the rich desiccant flowing within the absorber 210 and/or to provide a more tortuous flow path (e.g., compared to an unobstructed flow path) for ambient air flowing through the absorber 210 such that the air has a turbulent flow through the interior of the absorber 210. In some embodiments, the absorber 210 may be embodied as a counter flow vessel described above, with the rich desiccant (e.g., desiccant fluid) entering the absorber 210 at a desiccant vessel inlet located at or near the top of the absorber 210, and the ambient air inlet located at the bottom of the absorber 210. In some embodiments, the ambient air may flow upwards to a dry air exhaust located at or near the top of the absorber 210, and the desiccant fluid may flow downward, across the packing components, to a dilute desiccant outlet of the absorber 210. For example, in some embodiments, the packing components may include individual blocks, balls, trays, baffles and/or any other shape defining a plurality of baffles, slits, holes, meshes, and/or other flow modifying components that may be positioned within the absorber 210 to collectively define a highly tortuous path for the ambient air and the desiccant fluid to pass through the absorber 210. In some embodiments, the packing components may be formed of a material that is not reactive to the desiccant fluid. In some embodiments, a plurality of packing components (such as an unstructured packing component) may be positioned within the absorber 210 without physically connecting the packing components relative to one another. In some embodiments, a single packing component (such as a structured packing example) sized and shaped specifically for the interior of the absorber 210 may be provided and positioned within the absorber 210.

In some embodiments, the packing components may be placed in a structured configuration to define channels set at different angles to each other with or without holes that collectively define structured flow paths for the ambient air and the desiccant fluid flowing through the absorber 210. In some embodiments, to provide a structured packing configuration, the packing components may be placed in the absorber 210 in an ordered stacked manner. In some embodiments, packing components may also be positioned randomly in which a plurality of geometrically shaped components are randomly placed in the absorber 210 to increase surface area. In some embodiments, the desiccant fluid may be passed through the absorber 210 via other configurations (e.g., via atomization of a liquid desiccant fluid, spraying the desiccant fluid within the absorber and/or any other suitable method).

In some embodiments, in use of the AWG 200, the AWG 200 and/or one or more components thereof may be configured to direct ambient air (at an ambient temperature and an ambient humidity level) into the absorber 21. In some embodiments, the AWG 200 may include a blower implemented at the air intake to the absorber 210 to increase the volumetric flowrate of ambient air entering the absorber 210 (not shown). In some embodiments, in the absorber 210, the ambient air may contact a rich (concentrated) desiccant (e.g., desiccant fluid) provided to the absorber 210 at a low temperature, to increase the vapor pressure within the absorber to encourage water vapor within the humid ambient air to condense and to be absorbed by the desiccant fluid while the humid air contacts the rich desiccant. In some embodiments, while the ambient air and the desiccant fluid flow through the absorber 210, humidity within the air may condense and/or may be otherwise absorbed into the desiccant fluid to dilute the desiccant fluid and to dry the air. In some embodiments, the dry air may then exit the absorber back to the atmosphere, as indicated at 202. In some embodiments, the AWG 200 may include a blower 203 incorporated at an ambient air exhaust of the absorber 210 to increase the volumetric flowrate of air passing through the absorber 210. In some embodiments, the blower 203 may be provided in addition to, or as an alternative to, the above-mentioned blower placed at the ambient air intake of the absorber 210. Moreover, in some embodiments, once the desiccant fluid has passed through the absorber 210, a diluted, but still cool, desiccant fluid may exit the absorber 210 as indicated at reference 222.

In some embodiments, the AWG 200 may include a pump 223. In some embodiments, dilute desiccant (e.g., a desiccant fluid) may exit the absorber 210 to the pump 223. In some embodiments, the AWG 200 and/or one or more components thereof (e.g., the absorption module) may be configured to operate in a batch configuration where a series of valves may be configured to isolate the absorption module from other portions of the AWG 200, and to recirculate the dilute desiccant along a recirculation flow path (while additional rich desiccant fluid is prevented from entering the closed loop via flow path 237 while appropriate valves remain closed) and through a pre-absorber heat exchanger 225 (e.g., a shell-and-tube heat exchanger, a plate heat exchanger, and/or the like) to cool the dilute desiccant (the opposite side of the heat exchanger is cooled water that has been collected from the overall system, as discussed in greater detail herein) before it is passed back into the top of the absorber 210 as indicated at 221. For example, in some embodiments, the amount of water absorbed into the desiccant fluid may be increased (increasing the level of dilution of the desiccant) before the desiccant is directed to evaporation portions of the overall system.

In some embodiments, the AWG 200 may include a pre-absorber heat exchanger 225 as part of the absorption module. In some embodiments, the pre-absorber heat exchanger 225 may be cooled through the use of a chiller using a cooling media (e.g., water, glycol, and/or the like) that cools the rich desiccant flowing into the pre-absorber heat exchanger via flow path 224 (e.g., the cooling media is separated from the desiccant, such as on opposite sides of a heat exchanger) before the rich desiccant enters the absorber 210.

In some embodiments, the AWG 200 and/or one or more components thereof (e.g., the absorption module) may be configured to operate in a continuous configuration where valves are configured to recirculate a certain amount of dilute desiccant fluid along the recirculation flow path and a certain amount of dilute desiccant fluid flows toward the water extraction module through a separate flow path (flow path 226) connecting the absorption module and the water extraction module. In some embodiments, in this configuration, a certain amount of dilute desiccant fluid may flow along the recirculation flow path through the pre-absorber heat exchanger 225 (e.g., a shell-and-tube heat exchanger, a plate heat exchanger, and/or the like) to cool the dilute desiccant fluid (the opposite side of the heat exchanger 225 is cooled using water that has been collected from the overall system) before it is passed back into the top of the absorber 210 as indicated at 221. In some embodiments, dilute desiccant fluid may simultaneously traverse along a separate flow path 226 to the water extraction module. In some embodiments, the cooling fluid may pass through flow paths 261-267, which encompasses a recirculation loop of fluid, as well as a cooling system 262 and pump 264 that ensures adequate flow of fluid through the pre-absorber heat exchanger 225. In some embodiments, portions of the fluid may return to a fluid store via flow path 667.

In some embodiments, the AWG 200 may include the absorber 210 configured such that the rich desiccant is not cooled in a heat exchanger. In some embodiments, the AWG 200 and/or one or more components thereof may be configured to provide cooling of the desiccant fluid via thermal conductive heat exchange with ambient air through the conductive pipes along certain flow paths leading to an intake of the absorber. In some embodiments, fluid cooling may be provided in the absorber 210 as sensible heat is exchanged with the atmospheric air, provided that the air temperature is lower than the entering desiccant fluid temperature.

For example, in some embodiments, the AWG 200 and/or one or more components thereof may be configured to direct rich desiccant fluid moving toward the absorber 210 through a series of geothermal tubes having heat transfer properties with surrounding ground beneath the AWG 200. In some embodiments, the rich desiccant fluid may directly pass through the series of geothermal tubes, or the rich desiccant fluid may pass through a dual-fluid heat exchanger opposite a cooling fluid that is maintained at a desired low temperature via geothermal cooling. In some embodiments, the AWG 200 may include a heat exchanger (e.g., a shell-and-tube heat exchanger) configured to cool the desiccant fluid. In some embodiments, the heat exchanger may be cooled via a cooling solution that passes through a refrigeration circuit and/or other fluid chiller to absorb heat from the desiccant fluid before the desiccant fluid enters the absorber 210.

In some embodiments, the AWG 200 may be positioned proximate a high-pressure gas well, such as proximate a natural gas well, an oil well (where natural gas is extracted simultaneously with oil), and/or the like. In some embodiments, the AWG 200 and/or one or more components thereof may be configured to direct the high pressure gas through one or more expansion valves to regulate and/or decrease the pressure of the incoming gas, which, through the Joules-Thompson effect, experiences a rapid temperature decrease (following the gas law formula, the pressure of the gas rapidly decreases across the valve while the volume and amount of gas remains substantially constant, thereby causing a proportional rapid temperature decrease across the expansion valve). In some embodiments, the AWG 200 and/or one or more components thereof may be configured to pass the expanded and super-cooled gas through a heat exchanger opposite the rich desiccant fluid, thereby absorbing heat from the rich desiccant fluid and decreasing the temperature of the desiccant fluid prior to entry into the absorber 210. In some embodiments, the expanded gas may then be directed away from the AWG 200, where it may be collected for future use, flared off, utilized for power generation (e.g., via a steam turbine), and/or utilized to heat the desiccant fluid entering the water extraction module, as discussed herein.

In some embodiments, the AWG 200 may include the absorber 210 configured such that the diluted desiccant fluid exits the absorber 210 and is sent to the water extraction module without a recirculation path. In some embodiments, rich desiccant fluid returning from the water extraction module may or may not be cooled with a heat exchanger and/or chiller and/or geothermal cooling prior to entering the absorber 210. For example, in some embodiments, dilute desiccant that exits the absorber 210 may be pumped along a flow path extending between the absorption module and the water extraction module when appropriate valves are closed to prevent the dilute desiccant from recirculating into the absorber 210 as discussed above.

In some embodiments, the AWG 200 may include the absorber 210. In some embodiments, the absorber 210 may include a membrane-separated absorber, having a desiccant flow path on a first side of a porous membrane, and an air flow path on an opposite, second side of the porous membrane. In some embodiments, separating the air flow path from the desiccant solution flow path may impede undesirable mass flow of the desiccant salt (e.g., aqueous desiccant salt) itself into the air flow path and ultimately out of the AWG 200. In some embodiments, the AWG 200 and/or one or more components thereof (e.g., the absorber 210) may be configured such that water may be absorbed by the desiccant from the air based on osmotic water flow through the membrane from the air to the desiccant solution. In some embodiments, water vapor may condense on the second side of the membrane, travel through the membrane pores through capillary action, and be absorbed by the high-salt content concentrated desiccant solution.

In some embodiments, the membrane may be embodied as a porous membrane, having pores of adequate size (e.g., average pore diameter, maximum pore diameter, and/or the like) to enable water molecules to pass through the membrane while the desiccant salt is prevented from passing through the membrane. For example, in some embodiments, the porous membrane may include a non-woven material, such as polytetrafluorethylene (PTFE), expanded polytetrafluorethylene (ePTFE), polypropylene (PP), polyvinylidene fluoride (PVDF), and/or the like. In some embodiments, the porous membrane may include other materials (e.g., nylons and/or other synthetic materials). In some embodiments, the porous material may include synthetic and/or natural materials. In some embodiments, the porous membrane may be at least partially woven. In some embodiments, the membrane may include organic, inorganic, polymeric, mesoporous, ceramic, and/or other components. In some embodiments, the membrane may include metal organic frameworks, carbon nanotubes and/or a combination thereof. In some embodiments, the membrane may be hydrophilic and/or hydrophobic or may be treated (e.g., with a coating) to allow the membrane to be hydrophilic and/or hydrophobic. For example, in some embodiments, the membrane may be spiral wound, flat plate and frame style, or tubular. In some embodiments, as the desiccant solution and the water flow past opposite sides of the membrane, water molecules may migrate from the desiccant solution through the membrane (via capillary action), to the permeate water flow (e.g., water vapor and/or liquid water). In some embodiments, the membrane may be supported within a frame via spacers, such as a lattice, a grid, and/or the like to provide mechanical support for the membrane to maintain a desired orientation of the membrane within the housing.

In some embodiments, the AWG 200 may include a multi-stage absorber configuration as part of the absorption module, including a plurality of absorbers arranged in series (such that the desiccant flows from a first absorber, through a second absorber, and sequentially through additional absorbers within the multi-stage absorber configuration). In some embodiments, the multi-stage absorber configuration may encompass a plurality of absorbers arranged in parallel, such that the desiccant is split to flow through the plurality of absorbers in parallel.

Moreover, in some embodiments, the plurality of absorbers may be arranged in series within the air flow path, such that the AWG 200 and/or one or more components thereof may be configured to pull source air from the environment and pass the source air through the plurality of absorbers in series prior to exhausting the source air back to the environment as dry air. For example, in some embodiments, the AWG 200 and/or one or more components thereof may be configured to first pass the source air through the low concentration absorber to absorb a first quantity of water from the air, then pass the source air through the high concentration absorber to absorb a second quantity of water from the air. Without wishing to be bound by theory, in some embodiments, the initial absorption may use less energy (and may not use a low vapor pressure between the air and the liquid desiccant), with the lower concentration desiccant fluid being configured to perform the initial absorption generating a first quantity of water absorbed from the air. In some embodiments, after the initial, low energy requirement absorption process is completed, the air (which still contains water vapor) may be passed through the second absorber having a higher concentration desiccant fluid, such that a second quantity of water is absorbed from the air. In some embodiments, the now dry (e.g., low humidity) air may then be exhausted from the AWG 200 to the environment.

On the desiccant side, in some embodiments, once the dilute desiccant exits the low concentration absorber, the desiccant fluid may pass to a water extraction module as discussed herein to extract water therefrom (and to consequently reconcentrate the desiccant). In some embodiments, each absorber may be in fluid communication with a corresponding water extraction module, such that each absorber is associated with a separate and independent desiccant flow path loop. For example, in some embodiments, a first quantity of desiccant fluid may flow between a first absorber and a first water extraction module, and a second desiccant fluid may flow between a second absorber and a second water extraction module, and the first quantity of desiccant fluid does not mix with the second quantity of desiccant fluid. In some embodiments, the first quantity of desiccant fluid may include a first desiccant (e.g., LiCl) and the second quantity of desiccant fluid may include a second desiccant (e.g., CaCl).

Moreover, in some embodiments, the AWG 200 may include a plurality of independent desiccant flows, each desiccant flow having a different concentration range. For example, in some embodiments, a first desiccant flow (e.g., corresponding to a first absorber passed through by source air) may have a first concentration range measured between a high concentration value at an exit of the water extraction module and a low concentration value at an exit of the absorber, and a second desiccant flow may have a second concentration range. In some embodiments, as the source air is directed through the absorption columns in series, the AWG 200 and/or one or more components thereof may be configured to direct the air through a low concentration range absorption column first and through a high concentration range absorption column second.

In some embodiments, the AWG 200 may include a water extraction module configured to remove water from a diluted desiccant (e.g., from a diluted desiccant fluid) for storage and use as potable or other clean liquid water uses. In some embodiments, the water extraction module may include one or more membrane-based water extraction devices (e.g., connected in series or in parallel) and may be connected to the absorption module via various flow paths to enable desiccant (e.g., diluted desiccant and rich desiccant) to flow between the absorption module and the water extraction module. In some embodiments, the membrane-based water extraction device (also referred to as a fluid separation device) may also be configured to concentrate the desiccant solution into a concentrated desiccant retentate solution which may be reprocessed through the atmospheric water generation system.

In some embodiments, the AWG 200 may include a water extraction module having at least one membrane-based water extraction device 233 defining two flow paths separated by a permeable membrane 233a. In some embodiments, on a first side of the permeable membrane 233a, the desiccant may flow along a desiccant flow path (between flow path 232 and flow path 234) and on the opposite, second side of the permeable membrane, permeated fluid (e.g., water vapor) may be captured then transferred (within portion 233c, located within the water extraction device between flow path 250 and flow path 251). In some embodiments, both the desiccant (on the first side 233b of the permeable membrane 233a) and the captured permeate fluid (on the second side 233c of the permeable membrane 233a) may be in contact with opposite sides of the permeable membrane 233a while flowing past the permeable membrane 233a. In some embodiments, the membrane 233a may thereby separate the desiccant flow path from the captured permeate (water vapor) flow path, which may include water vapor collected during the water collection/fluid separation process (e.g., water vapor that migrates through the porous membrane 233a) and condenses into a liquid permeate water flow (e.g., downstream of the membrane-based water extraction device). In some embodiments, mass transfer of water vapor across the membrane 233a may be driven by raising the vapor pressure of the desiccant. In some embodiments, the AWG 200 and/or one or more components thereof may be configured to heat the desiccant prior to contact with the membrane 233a (on the desiccant side 233b of the membrane) to accomplish this. In some embodiments, the AWG 200 and/or one or more components thereof may be configured to lower the pressure (e.g., by using a vacuum mechanism) to reduce the pressure on the permeate side 233c of the membrane 233a, which also causes mass transfer of water vapor across the membrane. In some embodiments, as the desiccant flows past the porous membrane 233a (on the first, desiccant side 233b of the membrane), the water in the desiccant may begin permeation across the membrane 233a in the vapor state and exit the membrane 233a (on the second side) in the vapor state. In some embodiments, the water vapor may then condense as it cools and flows along the water flow path (e.g., at least partially by utilizing a heat exchanger (e.g. condenser 227) and/or contacting it with a colder fluid (e.g. condensed water)).

In some embodiments, the desiccant side 233b may be heated by a heating fluid (e.g., heating oil, steam, glycol, and/or the like) that is separated from the desiccant flow path within the membrane-based water extraction device via a heat-conductive layer (e.g., a heat-conductive, non-porous film, a metal sheet, and/or the like). In some embodiments, the desiccant side 233b may be embodied as a shell-and-tube heat exchanger, with the heating fluid flowing through tubes and the desiccant flowing through the shell, with certain wall(s) of the shell being embodied as the porous membrane 233a. In some embodiments, the heating fluid may be a product of the AWG 200, thereby utilizing sensible heat transfer to heat the desiccant fluid to encourage water vapor migration across the membrane. In some embodiments, the heating fluid may be a product (e.g., a final product, a waste product, or an intermediate product) of a spatially proximate process, such as mining, gas extraction, power production, and/or the like.

In some embodiments, the permeate side 233c may similarly include a heat-exchanger configuration to lower the temperature of the permeate fluid to encourage condensation thereof. For example, in some embodiments, a cooling fluid (e.g., liquid water extracted from a liquid water storage tank 255, a refrigerant (e.g., glycol), and/or the like) may be separated from the permeate flow path by a heat-conductive layer (e.g., a heat-conductive, non-porous film, a metal sheet, and/or the like). In some embodiments, the cooling fluid may cool the heat-conductive layer, thereby providing a surface within the permeate fluid flow on which water vapor can condense. In some embodiments, the permeate side 233c may be embodied as a shell-and-tube heat exchanger, with the cooling fluid flowing through tubes and the permeate fluid flowing through the shell, with certain wall(s) of the shell being embodied as the porous membrane 233a. In such embodiments, the outer surfaces of the tubes may be provided as condensation surfaces for the water vapor. In some embodiments, the cooling fluid may be a product of the AWG 200 (e.g., liquid water), thereby utilizing sensible heat transfer to cool the permeate to encourage water vapor migration across the membrane and to encourage condensation of the water vapor.

In some embodiments, the membrane 233a may include a hydrophobic porous membrane, such as non-woven membrane having a small pore size. For example, in some embodiments, the membrane may include PTFE, ePTFE, PP, PVDF, and/or the like, that is hydrophobic by design. In some embodiments, the membrane may be organic, inorganic, polymeric, mesoporous, ceramic, and/or the like. In some embodiments, the membrane may comprise metal organic frameworks, carbon nanotubes and/or a combination thereof, such as by stacking layers of material. In some embodiments, the membrane may be hydrophilic or hydrophobic or may be treated (e.g., with a coating) to allow the membrane to be hydrophilic and/or hydrophobic. In some embodiments, the use of a hydrophobic material (or a material having a hydrophobic coating) may encourage water vapor to selectively pass through the membrane to be retained on the permeate water side 233c of the membrane. In some embodiments, adhering a layer of hydrophobic material to the membrane on the desiccant side 233b may cause only volatile vapors to pass through and fluids in the liquid state may be retained on the desiccant side 233b of the membrane. For example, as membrane geometries, the membrane may be spiral wound, flat plate and frame style, or a hollow tube. In some embodiments, as the desiccant solution flows across the desiccant side 233b of the membrane, water molecules may migrate from the desiccant solution through the membrane (via capillary action) in the form of vapor, to the permeated water side 233c, leaving a highly concentrated desiccant solution on the desiccant side 233b of the membrane 233a.

In some embodiments, the membrane-based water extraction device 233 may be embodied as a housing having a desiccant inlet and a desiccant outlet on the desiccant side 233b of the membrane 233a, and a permeate inlet and a permeate outlet on the permeate side 233c of the membrane 233a. In some embodiments, the membrane-based water extraction device 233 may utilize gravity to remove permeate fluid from the membrane-based water extraction device 233, and in such embodiments, the permeate flow path need not include an inlet (such that gravity alone is sufficient to move the permeate fluid through an outlet of the device). For example, in some embodiments, as the desiccant fluid flows from an inlet to an outlet of the membrane-based water extraction device, water vapor may migrate through the membrane into vapor form on a permeate side of the membrane. In some embodiments, the permeate side of the membrane may be cooled (e.g., using a cooling fluid separated from the permeate side of the membrane by a heat-conductive film), and water may condense within the permeate side of the membrane-based water extraction device and may fall (under the force of gravity) through an outlet port located on a bottom end of the permeate-side of the membrane.

In some embodiments, the desiccant flow path may extend between the desiccant inlet and the desiccant outlet. In some embodiments, the permeate (water) flow path may extend between the permeate inlet and the permeate outlet. In some embodiments, the permeate outlet may be located below (and on an opposite end of the membrane-based water extraction device) the permeate inlet so as to utilize the force of gravity to encourage flow of permeate out of the membrane-based water extraction device. In some embodiments, each of the desiccant flow path and the permeate flow path may interface the porous membrane 233a on opposite sides thereof. In some embodiments, by separating the desiccant fluid from the permeate flow, the membrane 233a may impede mass transfer of dissolved solids from the desiccant into the resulting permeate flow, thereby preserving the desiccant for continuous usage and preserving the purity of the captured water. Similarly, in some embodiments, the membrane may impede migration of a gas (e.g., a sweep gas) on the permeate side of the membrane 233a from permeating into the desiccant flow.

In some embodiments, the housing may define two parallel flow paths that contact opposite sides of the porous membrane 233a in a counter-cross flow manner as illustrated in FIG. 2C, with the first flow path being the desiccant flow path 233b and the second flow path being the permeate flow path 233c, and the porous membrane 233a may be embodied as a planar membrane (e.g., defined within a frame) that separates the desiccant flow path 233b from the permeate flow path 233c. In some embodiments, the housing may be configured to grant access to the porous membrane for maintenance purposes, such as to replace the membrane as needed. In some embodiments, a first flow (e.g., the desiccant flow) may flow in a horizontal direction across the surface of the membrane 233a) and a second flow (e.g., the permeate flow) may flow in a vertical direction across the opposite surface of the membrane, such as with the outlet of the permeate flow being below the inlet of the permeate flow.

In some embodiments, the desiccant flow path may be defined by a desiccant inlet that directs the desiccant toward the membrane (e.g., at a perpendicular angle or an at least substantially perpendicular angle relative to a first side of the membrane), and the desiccant may be directed toward an outlet after the desiccant contacts the membrane. In some embodiments, this embodiment may be a dead end-style flow, where inlet desiccant interfaces the porous membrane in an at least substantially normal (perpendicular) direction of the permeate flow path on the opposite side of the membrane. In some embodiments, the permeate flow path may flow parallel to the porous membrane. An example of this configuration is illustrated in FIG. 2D.

In some embodiments, as illustrated in FIG. 2E, the housing may define a lumen-style flow path, with a first flow path being at least substantially concentric to a second flow path. In some embodiments, walls of the first flow path (separating the first and second flow path) may be at least partially defined by the porous membrane. In some embodiments, the porous membrane may extend partially around the first flow path. In some embodiments, the porous membrane may extend around an entirety of the first flow path. For example, in some embodiments, the first, interior flow path may be the desiccant flow path, and the second, outer flow path may be the permeate flow path, such that permeate water migrates through the porous membrane from the interior flow path to the exterior flow path. In some embodiments, the first, interior flow path may be the permeate water flow path and the second, outer flow path may be the desiccant flow path, such that permeate water migrates through the porous membrane from the exterior flow path to the interior flow path.

In some embodiments, in the lumen-style flow of the membrane-based water separation device, the permeate flow path and the desiccant flow paths may extend in the same co-current direction or in counter-current (opposite flow) directions. In some embodiments, the flows may be horizontal, or vertical. In some embodiments, in a vertical orientation, the permeate side may flow downward, thereby utilizing gravity to facilitate flow of the water (after condensation) out of the membrane-based water separation device.

In some embodiments, to achieve separation of water from the desiccant solution, a difference in chemical potential may be introduced. In some embodiments, this may be realized in a temperature gradient across the membrane, a pressure gradient across the membrane, and/or a concentration gradient across the membrane between the desiccant flow path 233b, the membrane 233a, and the permeate flow path 233c. In some embodiments, a temperature gradient across the membrane may be achieved by heating the desiccant fluid path 233b and/or cooling the permeate liquid water path 233c. In some embodiments, the temperature of the desiccant fluid and/or the liquid water may be manipulated through the use of any heating/cooling source to include but is not limited to, heat exchangers, heating elements, waste heat, geothermal heat, solar heating, geothermal cooling, chilling, cooling pond, cooling stream, sweep gas, and/or the like. For example, in some embodiments, the membrane-based water extraction device may incorporate a heat-exchanging configuration, such as across a non-porous film on a desiccant side of the membrane (e.g., a heating fluid may heat the desiccant fluid as it flows across a surface of the membrane) and/or a cooling configuration may be incorporated on the permeate side of the membrane (e.g., a cooling fluid separated from the permeate fluid across a non-porous film may cool the permeate fluid).

In some embodiments, a pressure gradient across the membrane may be achieved by high pressure on the desiccant side of the membrane and/or low pressure on the liquid water side of the membrane. In some embodiments, the difference in pressure between the desiccant side of the membrane and permeate side of the membrane may be introduced by the following mechanisms, including but not limited to high pressure pumps, pumps, blowers, compressors, vacuum pumps, venturi vacuum induction mechanisms, and/or the like. Moreover, in some embodiments, one or more pumps and/or agitators may be utilized on the desiccant side or the permeate water side to ensure homogeneity of properties of the desiccant and/or liquid water. In some embodiments, the difference in pressure and/or temperature may provide a difference in vapor pressure on the two sides of the membrane so as to encourage water vapor to migrate through the membrane from the desiccant side of the membrane to the permeate/water-vapor side of the membrane. In some embodiments, the vapor pressure on the permeate side of the membrane may be lower than the vapor pressure on the desiccant-side of the membrane (e.g., to utilize an induced vacuum to drive permeation of the water through the membrane).

In some embodiments, the AWG 200 may include the membrane-based water extraction device configured to utilize the mechanisms mentioned above to drive chemical potential. In some embodiments, incorporating vacuum membrane distillation (VMD), the permeate outlet path 251 may be pressurized to a vacuum pressure (e.g., utilizing one or more vacuum pumps located downstream of the membrane-based water extraction device 233 along the permeate flow path, such as at compressor 252) to induce a pressure gradient across the membrane. For example, in some embodiments, a vacuum pump may be located in the permeate water storage tank 255 and/or along flow path 259 of a gas vent from the water storage tank 255. In some embodiments, the absolute pressure on the desiccant side 233b may be greater than the absolute pressure on the permeate side 233c. In some embodiments, the interior of the membrane-based water extraction device may be analogous to that shown in FIGS. 2C-2E. In some embodiments, additional components, such as a heating fluid flow and/or a cooling fluid flow (as discussed below) may additionally be incorporated into the VMD configuration of the membrane-based water extraction device to further enhance the efficiency of the water extraction process.

In some embodiments, the AWG 200 and/or one or more components thereof may be configured to utilize air gap membrane distillation (AGMD) processes to drive permeation of water vapor across the membrane 233a to the permeate side 233c of the membrane 233a. Example AGMD configurations are shown in FIGS. 2F-2G, each of which provides for the permeate side of the membrane 233c to carry a cooling fluid along a cooling fluid flow path that is separated from the permeate flow path 233c by a heat-conductive, non-porous film (e.g., cooling water directed from storage tank 255, along flow path 258 to flow path 250 and into the membrane-based water extraction device 233 on the permeate side 233c of the membrane 233a). In some embodiments, the cooling fluid flowing along flow path 233d may sandwich an air gap between a non-porous membrane 233e (separating the cooling fluid flow path 233d from the permeate side 233c of the membrane) and porous membrane 233a. In some embodiments, the created air gap may be formed with non-porous membranes 233e that promote condensing via heat transfer. In some embodiments, the air gap may serve as a path for condensates once they have separated from the desiccant via porous membrane.

In some embodiments, the cooling fluid may be at a temperature below the heated desiccant fluid, thereby creating a temperature gradient starting from the heated desiccant side of the module 233b and finishing at the cool non-porous membrane holding the cooling fluid. In some embodiments, the cool side may also cause the transferred vapors to condense into a liquid state. In some embodiments, a higher temperature gradient (a greater difference between the heated desiccant fluid and the cooling fluid) may create a greater driving force to separate water molecules within the concentrated desiccant across the porous membrane, thus achieving greater separation performance for the membrane-based water extraction device. In some embodiments, the water vapor within the air gap may be directed out of the housing of the membrane-based water extraction device based on a vacuum created within the air gap, based on a sweep gas flowing through the air gap, and/or based on gravity that forces condensed water to flow downward and out through an outlet located at a bottom end of the air gap.

In some embodiments, the housing may define three outlets: a desiccant outlet (to flow path 234), a permeate outlet (to flow path 251), and a cooling fluid outlet (to recirculate cooling fluid along a cooling fluid flow path). In some embodiments, the housing may define at least two inlets (when an inlet is not required for the permeate fluid, such as when gravity is utilized to direct the permeate fluid to exit the air gap) comprising a desiccant inlet (from flow path 232) and a cooling fluid inlet (e.g., from flow path 250). In some embodiments, the housing may define at least 3 inlets (when a permeate flow inlet is required, such as when utilizing a vacuum pressure or a sweep gas to direct the permeate out of the housing), comprising a desiccant fluid inlet (from flow path 232), a permeate fluid inlet (e.g., to enable a gas flow through the permeate side 233c of the membrane), and a cooling fluid inlet (e.g., from flow path 250).

Although illustrated as a flat-plane non-porous membrane 233d, it should be understood that in some embodiments, the permeate side of the membrane 233a may be embodied as a shell-and-tube heat exchanger configuration (with the walls of the tubes embodying the non-porous film 233e and the cooling fluid flowing within the interior of the tubes).

Moreover, in some embodiments, the AWG 200 may include an analogous configuration on the desiccant side of the membrane by utilizing a heating fluid separated from the desiccant by a non-porous, heat-conductive film, as shown in FIG. 2G. In some embodiments, the heating fluid (e.g., a heating oil, steam, a heated refrigerant, and/or the like) may pass along a flow path through heating fluid flow 233f, on an opposite side of the non-porous film 233g from the desiccant fluid 233b. In some embodiments, the heating fluid may transfer heat to the desiccant flowing through desiccant flow 233b, which may encourage water vapor transmission across the porous membrane 233a. In some embodiments, particularly when the heating fluid flow 233f configuration is incorporated together with the cooling fluid flow 233d configuration, a large difference in chemical potential may be introduced between the desiccant flow 233b and the permeate flow 233c to encourage migration of water across the membrane 233a. In some embodiments, the water vapor within the air gap may be directed out of the housing of the membrane-based water extraction device based on a vacuum created within the air gap, based on a sweep gas flowing through the air gap, and/or based on gravity that forces condensed water to flow downward and out through an outlet located at a bottom end of the air gap.

In some embodiments, the housing may define three outlets: a desiccant outlet (to flow path 234), a permeate outlet (to flow path 251), a heating fluid outlet (e.g., to recirculate the heating fluid along a heating fluid flow path) and a cooling fluid outlet (to recirculate cooling fluid along a cooling fluid flow path). In some embodiments, the housing may define at least three inlets (when an inlet is not required for the permeate fluid, such as when gravity is utilized to direct the permeate fluid to exit the air gap) comprising a desiccant inlet (from flow path 232), a heating fluid inlet, and a cooling fluid inlet (e.g., from flow path 250). In some embodiments, the housing may define at least four inlets (when a permeate flow inlet is required, such as when utilizing a vacuum pressure or a sweep gas to direct the permeate out of the housing), comprising a desiccant fluid inlet (from flow path 232), a permeate fluid inlet (e.g., to enable a gas flow through the permeate side 233c of the membrane), a heating fluid inlet, and a cooling fluid inlet (e.g., from flow path 250).

In some embodiments, by separating the permeate flow 233c from the cooling fluid 233d as illustrated in either of FIGS. 2F-2G, the efficiency of permeation of water through the membrane may be increased due to a low vapor-pressure on the permeate side 233c of the membrane. In some embodiments, the AWG 200 and/or one or more components thereof may be configured to implement a vacuum pressure, a sweep gas, and/or other flow-encouraging mechanisms within the permeate flow 233c to encourage the water vapor on the permeate side 233c of the membrane to exit through the permeate outlet of the membrane-based water extraction device 233 and to be guided to one or more compressors (to incorporate beneficial features of mechanical vapor compression). In some embodiments, the AWG 200 and/or one or more components thereof may be configured to direct the water vapor exiting the permeate outlet of the membrane-based water extraction device to one or more heat exchangers and/or one or more condensers 227 to condense the water vapor into liquid water before storing the same within storage tank 255.

In some embodiments, the AWG 200 and/or one or more components thereof may be configured to implement direct contact membrane distillation (DCMD) processes to drive chemical potential across the membrane 233a. In some embodiments, in a DCMD configuration, the permeate water side 233c of the membrane 233a may carry a cooling fluid (e.g., cooling water) that directly contacts the porous membrane 233a. In some embodiments, the AWG 200 and/or one or more components thereof may be configured to direct water from the storage tank 255 directly to the permeate flow 233c so as to maintain a low temperature on the permeate side 233c of the membrane 233a. In some embodiments, because the cooling fluid may be at a lower temperature than the desiccant fluid, the cooling fluid may create a temperature gradient across the membrane 233a, starting from the heated desiccant side 233b and finishing at the direct contacting cooling fluid on the permeate side 233c of the membrane 233a.

In some embodiments, the cooling fluid may be retrieved from the storage tank 255 and directed into the membrane-based water extraction device 233 along flow paths 258 to 250 to 233c (and out of the membrane-based water extraction device at flow path 251). In some embodiments, a portion of the water exiting the storage tank 255 along flow path 258 may be directed to external systems for use as liquid water. In some embodiments, the permeate side 233c of the membrane 233a may be fed by cooling fluid (e.g., liquid water from storage tank 255), which may cause water vapors that have permeated through the membrane 233a to condense and transfer the water vapors separated from the concentrated desiccant. In some embodiments, a higher temperature gradient (a greater difference between the heated desiccant fluid and the cooling fluid) may create a greater driving force to separate water molecules within the concentrated desiccant across the porous membrane, thus achieving greater separation performance for the membrane-based water extraction device.

In some embodiments, the AWG 200 and/or one or more components thereof may be configured to utilize a sweep gas membrane distillation (SGMD) process to create a chemical difference across the membrane 233a. In some embodiments, SGMD configurations may be combined with AGMD and/or DCMD to drive further efficiency of such configurations. In some embodiments, according to an SGMD configuration, the permeate water side 233c of the membrane 233a may carry a sweep gas (e.g., nitrogen gas, high-humidity air, inert gas, and/or the like) that transports permeated fluid (e.g., water vapor) away from the porous membrane 233a after it has permeated through the porous membrane. In some embodiments, the AWG 200 and/or one or more components thereof may be configured to direct the sweep gas carrying the permeated water vapor to a compressor 252 and/or a condenser 227, where the water vapor condenses into liquid water.

In some embodiments, the sweep gas may be separated from the permeated water vapors by bringing the mixture to the water dew point and ultimately the sweep gas may be directed away from the liquid water along flow path 259, leading out of the storage tank 255. In some embodiments, the sweep gas may be directed back to a storage tank, and it may be recycled into the system along flow path 260 as discussed above. In some embodiments, condensing the permeated water vapor into liquid may enable the water to be stored in the product water tank 255. In some embodiments, the SGMD configuration may utilize an inert gaseous state fluid as a sweep gas that does not contaminate the product water. In some embodiments, the flow of gas into the permeate flow path 233c may be heated to retain the physical state of the permeated water (vapor state). In some embodiments, the AWG 200 and/or one or more components thereof may include heat tracing elements configured to prevent the fluid pipe walls from cooling the fluid to liquid state. In some embodiments, the water vapor may then be transported to a condenser 227 downstream from the membrane-based water extraction device 233 to condense the water, which may then be stored within the water storage tank 255. Moreover, in some embodiments, the AWG 200 and/or one or more components thereof may be configured to introduce the sweep gas along flow path 260 and 250 into the membrane-based water extraction device. In some embodiments, the sweep gas may be directed away from the liquid water after condensation by directing the sweep gas out of the water storage tank, such as along flow path 259 as shown in FIG. 2B.

In some embodiments, the water extraction module may include one or more heating mechanisms along a flow path leading the desiccant fluid into the intake of the membrane-based water extraction device (on the desiccant side 233b of the membrane 233a). In some embodiments, the AWG 200 and/or one or more components thereof may be configured to heat the desiccant fluid to a temperature between about 40-80° C. In some embodiments, the process may result in adequate separation even at low temperatures (approximately 40° C.). In some embodiments, the efficiency of separation may be increased at higher temperatures (e.g., between about 60-80° C.).

For example, in some embodiments, diluted desiccant leaving the absorption module may pass through one or more heating subsystems between the absorption module and the membrane-based water extraction device. In some embodiments, these heating subsystems may be provided as a part of the water extraction module. In some embodiments, the AWG 200 may include one or more heating subsystems comprising one or more of: a condenser 227, a pre-extraction heat exchanger 229, and/or a heater 231. It should be understood that the one or more heating subsystems may be provided in any order relative to the flow of desiccant. In some embodiments, the diluted desiccant, which may remain cool after passing through the absorber 210, may pass through a condenser 227 which utilizes the generally cool temperature of the dilute desiccant to encourage condensation of water vapor from water vapor flowing along the permeate water flow path 251-254 (e.g., the water flow path encompassing the water flow path on the second side of the porous membrane).

In some embodiments, the condenser 227 may be a shell-and-tube heat exchanger, with the dilute desiccant (upstream of the membrane-based water extraction device 233) passing through the tubes, and the water vapor condensing on the exterior of the tubes within the shell of the heat exchanger. In some embodiments, the condenser 227 may be a plate-and-frame heat exchanger, with the dilute desiccant fluid passing through one set of plates and the water vapor passing through the other set of plates, and the water vapor may condense in the heat exchanger as it traverses through the heat exchanger as it warms the dilute desiccant. In some embodiments, the condenser 227 may be a double-pipe heat exchanger where the dilute desiccant passes through the inner pipe and the water vapor passes through the outer pipe such that it can condense on the exterior surface of the inner pipe. In some embodiments, the condenser 227 may have a counter-flow configuration (the dilute desiccant flowing in an opposite direction than the water vapor). In some embodiments, the condenser 227 may have a parallel, co-current flow configuration in which the dilute desiccant and the water vapor flow in the same direction through the condenser 227.

In some embodiments, the dilute desiccant exiting the condenser 227 via the flow path represented at 228 may have an increased temperature due to a certain amount of heat transfer that is transferred from the water vapor to the dilute desiccant within the condenser 227. In some embodiments, the AWG 200 may include a pre-evaporator heat exchanger 229 (e.g., a shell-and-tube heat exchanger, a plate-and-frame heat exchanger, a dual-tube heat exchanger (with concentric tubes), and/or the like) and/or a heater 231 (e.g., an externally powered heater, such as an electric heater, a natural gas heater, a solar heater and/or the like) configured to increase the temperature of the dilute desiccant to or near the evaporation temperature. In some embodiments, the heater may be an inline electric heater with heating element bundles for heating the dilute desiccant fluid. In some embodiments, the heater may have an orientation to reduce the likelihood of fluid flashing on the elements. In some embodiments, the heater 231 may be positioned within the housing of the membrane-based water extraction device. In some embodiments, the heater may be a heat exchanger (e.g., a shell-and-tube heat exchanger, a plate-and-frame heat exchanger, and/or the like). In some embodiments, the heater 231 may be a solar heater utilizing photovoltaic panels to generate electrical energy to drive electrical heater elements (e.g., resistive heater elements). In some embodiments, the heater 231 may be a frenal lens heater utilizing solar energy to generate thermal energy in the form of heat. In some embodiments, the heater 231 may include a geothermal heater mechanism including a series of pipes extending into the ground to utilize geothermal energy to heat the dilute desiccant fluid. In some embodiments, the heater 231 may be a fired heater utilizing a hydrocarbon fuel source (e.g., natural gas, oil, wood, biomass, and/or the like) combined with oxygen (supplied from ambient air) to create heat from combustion.

In some embodiments, in embodiments including both a pre-extraction heat exchanger 229 and heater 231, the dilute desiccant fluid may first exit the pre-extraction heat exchanger 229 via flow path represented at 230 before entering the heater 231. Moreover, as discussed in greater detail herein, the opposite side of the pre-extraction heat exchanger 229 may be provided with heated rich desiccant fluid exiting the membrane-based water extraction device.

In some embodiments, as the desiccant flows out of the heater 231 (if used), it may flow along a flow path 232 into the housing, specifically into the desiccant inlet of the membrane-based water extraction device. In some embodiments, in the membrane-based water extraction device, the desiccant solution may be brought into direct contact with the membrane. In some embodiments, utilizing the difference in temperature, pressure, and/or concentration, the water may migrate though the membrane and may be collected on the second side. In some embodiments, the water may migrate through the membrane as a liquid and/or as a vapor. In some embodiments, the water may then be distributed for use and/or collected in a storage tank 255. In some embodiments, the vapor on the liquid water side of the membrane may be collected in cool liquid water or another cool fluid to condense the vapor. In some embodiments, the AWG 200 and/or one or more components thereof may be configured to sweep the vapor on the liquid water side of the membrane away from the membrane using a sweep gas that flows through the membrane-based water extraction device on the liquid water side of the membrane.

In some embodiments, the vapor may then be condensed in a further process using a heat transfer process such as a heat exchanger or other embodiment of heat transfer process to condense the water vapor into liquid water (the opposite side of the heat exchanger and/or condenser may define a portion of a flow path of a chilled fluid, such as the dilute desiccant prior to entry into the desiccant side of the membrane-based water extraction device). In some embodiments, the vapor may directly enter a heat transfer process on the permeate side of the membrane after exiting the membrane-based water extraction device 233. In some embodiments, the heat transfer process may be a heat exchanger 229 or other embodiment of heat transfer process to condense the water vapor into liquid water. In some embodiments, a vacuum may be induced on the permeate side of the membrane to achieve a difference in pressure between the desiccant side and permeate side of the membrane. In some embodiments, the water may enter the membrane as a liquid and/or vapor and exit the membrane on the permeate side as a vapor. In some embodiments, the water flow path may lead the water into a storage tank 255 (via flow paths 251-254, inclusive of pump(s), heat exchanger(s), compressor(s), and/or other flow-assisting devices). In some embodiments, the water flow path may also circulate from the storage tank via flow path 250 (inclusive of one or more pumps in some embodiments, not shown) to the membrane-based water extraction device 233. In some embodiments, the AWG 200 and/or one or more components thereof may be configured to blow a sweep gas (e.g., humid air) through the water flow path (e.g., via a blower in-line with the water flow path) to push water vapor out of the membrane-based water extraction device 233 into the compressor 252 and ultimately into the condenser 227.

In some embodiments, the AWG 200 and/or one or more components thereof may be configured to compress the vapor on the permeate side through mechanical and/or thermal means to a higher pressure (e.g., via compressor 252). In some embodiments, the vapor may then be passed through a heat exchanger to allow the latent heat to be used to heat the desiccant solution. In some embodiments, through this heat exchanger the vapor may also be condensed as a liquid.

In some embodiments, the membrane-based water extraction device 233 may be configured for batch operation, in which the desiccant may circulate within a closed loop to repeatedly contact the desiccant fluid with the membrane (without directing the desiccant to the absorption module) until a desired quantity of water has been separated. In some embodiments, valves within the water extraction module may be configured to provide the closed-loop flow of the desiccant solution. In some embodiments, after the concentration of the desiccant solution reaches a desired level, the desiccant solution may then be sent back to the absorption module by reconfiguring the valves to enable flow of desiccant from the water extraction module to the absorption module. In some embodiments, the membrane-based water extraction device 233 may encompass a system of parallel subunits where multiple membranes are held in a single apparatus and/or multiple membrane-based water extraction devices are operated in parallel (with each device operating to separate water from a portion of the desiccant solution). In some embodiments, the membrane separation subunits may also be configured in a series configuration. In some embodiments, in this configuration, the desiccant solution may be contacted with the first membrane and a certain amount of water may migrate through the first membrane. In some embodiments, the retentate desiccant solution from the first membrane may be fed to a second membrane as the desiccant solution where an additional quantity of water may be separated from the desiccant solution. In some embodiments, the process may be repeated for the number of membrane separation subunits in the series setup. In some embodiments, a combination of the parallel and series units may be utilized.

In some embodiments, the membrane-based water extraction device 233 may be configured for continuous operation where a stream of desiccant flow in direct contact (e.g., perpendicular, parallel or tangential to the membrane face) with the membrane, and water may be continuously separated from the desiccant solution via the membrane. In some embodiments, the continuous mode operation may utilize series and/or parallel subunits as described in the section above. In some embodiments, during continuous operation, the desiccant may flow in a continuous loop from the absorption module to the water extraction module and back to the absorption module.

In some embodiments, the AWG 200 may include the membrane-based water extraction device provided in combination with an evaporation-based water extraction device (e.g., an evaporation vessel for evaporating water from the desiccant, and a condenser for condensing the evaporated water into potable liquid water). For example, in some embodiments, the membrane-based water extraction device may be provided upstream (along the desiccant flow path) from an evaporation vessel. In some embodiments, the membrane-based water extraction device may alternatively (or additionally) be positioned downstream (along the desiccant flow path) of an evaporation vessel as discussed above.

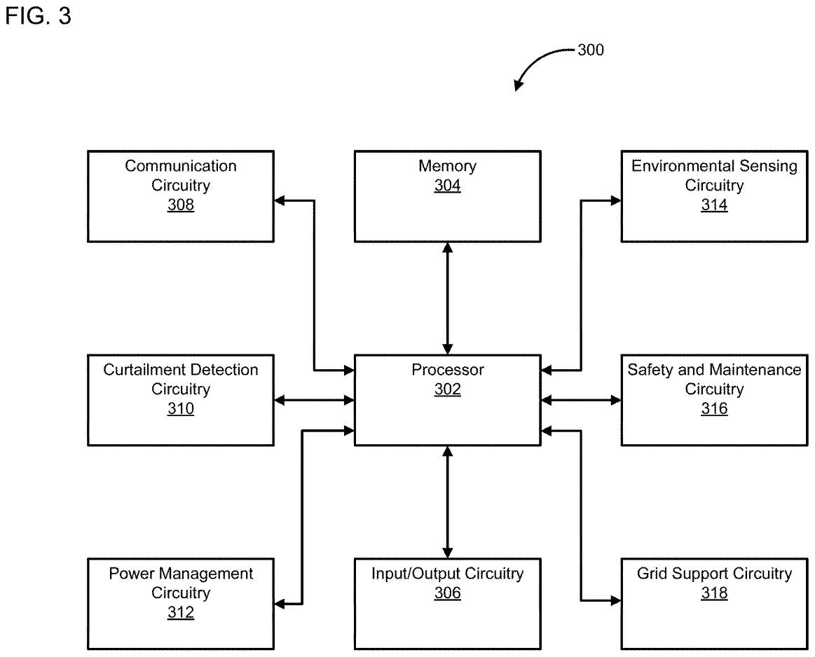

FIG. 3 is a block diagram of a controller circuitry 300 (also referred to herein as the apparatus 300), according to an embodiment. It should be noted, however, that the components, or elements illustrated in and described with respect to FIG. 3 may not be mandatory and thus one or more may be omitted in some embodiments. Additionally, in some embodiments, the controller circuitry 300 may include further or different components or elements beyond those illustrated in and described with respect to FIG. 3. In some embodiments, the apparatus 300 may include one or a plurality of physical devices.

In some embodiments, the apparatus 300 may include processor 302, memory 304, input/output circuitry 306, communications circuitry 308, curtailment detection circuitry 310, power management circuitry 312, an environmental sensing circuitry 314, a safety and maintenance circuitry 316, and/or a grid support circuitry 318. In some embodiments, the apparatus 300 may be configured to execute the operations described herein. Although these components 302-318 are described with respect to functional limitations, it should be understood that the particular implementations necessarily include the use of particular hardware. It should also be understood that certain of these components 302-314 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. In some embodiments, the memory 304 may be non-transitory and may include, for example, one or more volatile and/or non-volatile memories. In other words, for example, the memory 304 may be an electronic storage device (e.g., a computer-readable storage medium). In some embodiments, the memory 304 may be configured to store information, data, content, applications, instructions, or the like for enabling the apparatus to carry out various functions in accordance with some embodiments of the present invention.

In some embodiments, the processor 302 may be embodied in a number of different ways and may, for example, include one or more processing devices configured to perform independently. In some embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some embodiments, the processor 302 may be configured to execute instructions stored in the memory 304 or otherwise accessible to the processor 302. In some embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions, the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. In some embodiments, the input/output circuitry 306 may include a user interface and may include a display, and may include a web user interface, a mobile application, a query-initiating computing device, a kiosk, or the like. In some embodiments, the input/output circuitry 306 may also include a keyboard, a mouse, a joystick, a touch screen, touch areas, soft keys, a microphone, a speaker, or other input/output mechanisms. In some embodiments, the processor and/or user interface circuitry including the processor may be configured to control one or more functions of one or more user interface elements through computer program instructions (e.g., software and/or firmware) stored on a memory accessible to the processor (e.g., memory 304, and/or the like).

In some embodiments, the communications circuitry 308 may be any means such as a device or circuitry embodied in either hardware or a combination of hardware and software that is configured to receive and/or transmit data from/to a network and/or any other device, circuitry, or determination in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

Additionally, or alternatively, in some embodiments, two or more of the sets of circuitries embodying processor 302, memory 304, input/output circuitry 306, and/or communications circuitry 308 may be combinable. Alternatively, or additionally, in some embodiments, one or more of the sets of circuitry may perform some or all of the functionality described associated with another component. For example, in some embodiments, two or more of the sets of circuitry embodied by processor 302, memory 304, input/output circuitry 306, and communications circuitry 308 may be combined into a single determination. Similarly, in some embodiments, one or more of the sets of circuitry 302-314 may be combined with the processor 302, such that the processor 302 performs one or more of the operations described above with respect to each of these sets of circuitry.

In some embodiments, the apparatus 300 may include a curtailment detection circuitry 310 which may include hardware elements, with or without enabling software elements, firmware elements, or a combination thereof configured to, with the processor 302, input/output circuitry 306 or communications circuitry 308, perform one or more functions associated with the curtailment determination 114A (as described above with reference to FIG. 1B). For example, in some embodiments, the curtailment detection circuitry 310 may access, facilitate access, receive, process, manipulate, provide, or otherwise use, or make available for use, certain data used by one or more other elements of the apparatus 300 through, for example, the use of hardware, software, applications, or APIs executed using a processor, such as the processor 302. In some embodiments, the curtailment detection circuitry 310 may interact with the memory 304, which may store the aforementioned data. It should also be appreciated that, in some embodiments, the curtailment detection circuitry 310 may include a separate processor, specially configured field programmable gate array (FPGA), or application specific interface circuit (ASIC) to receive such data utilized by the curtailment detection circuitry 310. In some embodiments, the curtailment detection circuitry 310 may also provide for communication with other elements of the apparatus 300, system or external systems via a network interface provided by the communications circuitry 308. In some embodiments, one or more portions of the curtailment detection circuitry 310 and processor 302 may be integrated into a single circuitry or group of circuitries, with or without various other circuitries discussed herein, configured to execute the respective functionalities thereof.

In some embodiments, the apparatus 300 may include a power management circuitry 312 which may include hardware elements, with or without enabling software elements, firmware elements, or a combination thereof configured to, with the processor 302, input/output circuitry 306 or communications circuitry 308, perform one or more functions associated with the power management determination 114B (as described above with reference to FIG. 1B). For example, in some embodiments, the power management circuitry 312 may access, facilitate access, receive, process, manipulate, provide, or otherwise use, or make available for use, certain data used by one or more other elements of the apparatus 300 through, for example, the use of hardware, software, applications, or APIs executed using a processor, such as the processor 302. In some embodiments, the power management circuitry 312 may interact with the memory 304, which may store the aforementioned data. It should also be appreciated that, in some embodiments, the power management circuitry 312 may include a separate processor, specially configured field programmable gate array (FPGA), or application specific interface circuit (ASIC) to receive such data utilized by the power management circuitry 312. In some embodiments, the power management circuitry 312 may also provide for communication with other elements of the apparatus 300, system or external systems via a network interface provided by the communications circuitry 308. In some embodiments, one or more portions of the power management circuitry 312 and processor 302 may be integrated into a single circuitry or group of circuitries, with or without various other circuitries discussed herein, configured to execute the respective functionalities thereof.

In some embodiments, the apparatus 300 may include an environmental sensing circuitry 314 which may include hardware elements, with or without enabling software elements, firmware elements, or a combination thereof configured to, with the processor 302, input/output circuitry 306 or communications circuitry 308, perform one or more functions associated with the environmental sensing determination 114C (as described above with reference to FIG. 1B). For example, in some embodiments, the environmental sensing circuitry 314 may access, facilitate access, receive, process, manipulate, provide, or otherwise use, or make available for use, certain data used by one or more other elements of the apparatus 300 through, for example, the use of hardware, software, applications, or APIs executed using a processor, such as the processor 302.

In some embodiments, the environmental sensing circuitry 314 may interact with the memory 304, which may store the aforementioned data. It should also be appreciated that, in some embodiments, the environmental sensing circuitry 314 may include a separate processor, specially configured field programmable gate array (FPGA), or application specific interface circuit (ASIC) to receive such data utilized by the environmental sensing circuitry 314. In some embodiments, the environmental sensing circuitry 314 may also provide for communication with other elements of the apparatus 300, system or external systems via a network interface provided by the communications circuitry 308. In some embodiments, one or more portions of the environmental sensing circuitry 314 and processor 302 may be integrated into a single circuitry or group of circuitries, with or without various other circuitries discussed herein, configured to execute the respective functionalities thereof.

In some embodiments, the apparatus 300 may include a safety and maintenance circuitry 316 which may include hardware elements, with or without enabling software elements, firmware elements, or a combination thereof configured to, with the processor 302, input/output circuitry 306 or communications circuitry 308, perform one or more functions associated with the safety and maintenance determination 114D (as described above with reference to FIG. 1B). For example, in some embodiments, the safety and maintenance circuitry 316 may access, facilitate access, receive, process, manipulate, provide, or otherwise use, or make available for use, certain data used by one or more other elements of the apparatus 300 through, for example, the use of hardware, software, applications, or APIs executed using a processor, such as the processor 302. In some embodiments, the safety and maintenance circuitry 316 may interact with the memory 304, which may store the aforementioned data. It should also be appreciated that, in some embodiments, the safety and maintenance circuitry 316 may include a separate processor, specially configured field programmable gate array (FPGA), or application specific interface circuit (ASIC) to receive such data utilized by the safety and maintenance circuitry 316. In some embodiments, the safety and maintenance circuitry 316 may also provide for communication with other elements of the apparatus 300, system or external systems via a network interface provided by the communications circuitry 308. In some embodiments, one or more portions of the safety and maintenance circuitry 316 and processor 302 may be integrated into a single circuitry or group of circuitries, with or without various other circuitries discussed herein, configured to execute the respective functionalities thereof.

In some embodiments, the apparatus 300 may include a grid support circuitry 318 which may include hardware elements, with or without enabling software elements, firmware elements, or a combination thereof configured to, with the processor 302, input/output circuitry 306 or communications circuitry 308, perform one or more functions associated with the grid support determination 114E (as described above with reference to FIG. 1B). For example, in some embodiments, the grid support circuitry 318 may access, facilitate access, receive, process, manipulate, provide, or otherwise use, or make available for use, certain data used by one or more other elements of the apparatus 300 through, for example, the use of hardware, software, applications, or APIs executed using a processor, such as the processor 302. In some embodiments, the grid support circuitry 318 may interact with the memory 304, which may store the aforementioned data. It should also be appreciated that, in some embodiments, the grid support circuitry 318 may include a separate processor, specially configured field programmable gate array (FPGA), or application specific interface circuit (ASIC) to receive such data utilized by the grid support circuitry 318. In some embodiments, the grid support circuitry 318 may also provide for communication with other elements of the apparatus 300, system or external systems via a network interface provided by the communications circuitry 308. In some embodiments, one or more portions of the grid support circuitry 318 and processor 302 may be integrated into a single circuitry or group of circuitries, with or without various other circuitries discussed herein, configured to execute the respective functionalities thereof.

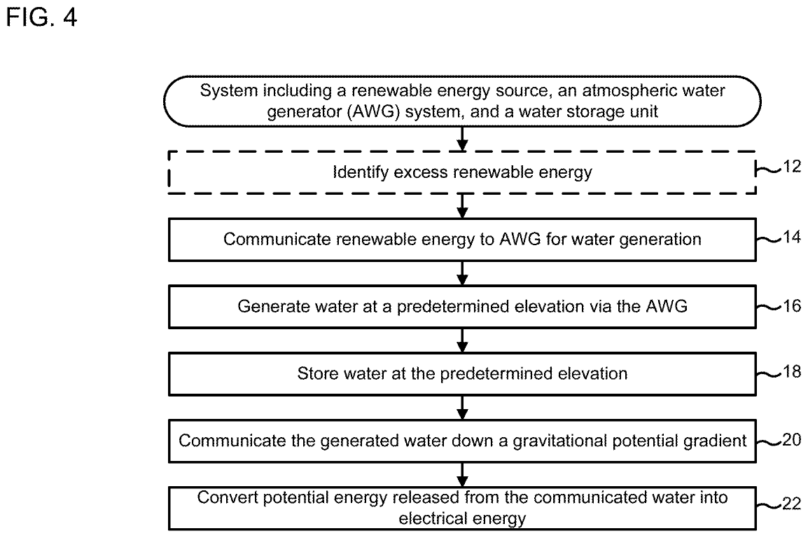

FIG. 4 is a block diagram of a method 400 of atmospheric water generation at elevation, according to an embodiment. In some embodiments, the method 400 may include or be performed by the system 101 as described herein with respect to FIG. 1A. For example, in some embodiments, the system 101 may include the AWG system 106, the water storage and distribution system 110, the energy generation system 160, any suitable components thereof, and/or any of the features described herein with respect to FIG. 1A. Accordingly, operations of the method 400 may be performed by any suitable features of the system 101. While described with respect to the system 101 of FIG. 1A and features thereof, in some embodiments, operations of the method 400 may include or be performed by any suitable systems (e.g., systems 101c and/or 101d) and/or features thereof as described herein. All such variations are envisioned herein and should be considered as part of the present disclosure.

In some embodiments, the method 400 may optionally include identifying an excess quantity of renewable energy (i.e., curtailed energy), at 12. For example, in some embodiments, the system 101 may include the controller 104. In some embodiments, the controller 104 may be configured to identify surplus renewable energy by monitoring the output of the renewable energy system 102 and comparing it to the current demand of the electrical grid 108 or a local load.

In some embodiments, the method 400 may include, communicating at least a portion of the identified excess renewable energy to the AWG system 106 for water generation, at 14. For example, in some embodiments, the controller 104 may direct the excess energy to the AWG system 106 to enable water generation therefrom. In some embodiments, the controller 104 may incrementally activate, ramp up, ramp down, or deactivate the AWG system 106 based on the amount of excess energy available.

In some embodiments, the method 400 may include generating water at a predetermined elevation via the AWG system 106, at 14. For example, in some embodiments, the AWG system 106 may generate water from ambient air using one or more of the techniques described herein, including cooling condensation, desiccant-based absorption, membrane-based extraction, or any combination thereof.

In some embodiments, the method 400 may include, storing at least a portion of the generated water at the predetermined elevation, at 18. For example, in some embodiments, the system 101 may include the water storage and distribution system 112 configured to store at least a portion of the water generated by the AWG system 106. In some embodiments, the stored water may accumulate gravitational potential energy by virtue of the elevation at which it is stored.

In some embodiments, the method 400 may include, communicating at least a portion of the stored water down a gravitational potential energy gradient, at 20. For example, in some embodiments, the water storage and distribution module 112 may be configured to communicate at least a portion of the stored water to the energy generation system 160, which is disposed at a lower elevation than the water storage and distribution system 112. In some embodiments, the communication of water from the higher elevation to the lower elevation may be triggered by the controller 104 in response to detecting that the water storage and distribution system 112 has reached a predetermined threshold level, in response to a demand signal, or in response to any other suitable condition.

In some embodiments, the method 400 may include converting at least a portion of the gravitational potential energy released by the communicated water to energy, at 22. In some embodiments, the energy generation system 160 may convert the gravitational potential energy of the communicated water into electrical energy, mechanical energy, or any other form of useable energy. In some embodiments, the converted energy may be communicated to at least one of the AWG system 106, the energy storage system 110, the electrical grid 108, or any other coupled system or load.

While specific embodiments, of the present disclosure have been outlined above, many alternatives, modifications, and variations will be apparent to those skilled in the art. Accordingly, the embodiments, set forth herein area intended to be illustrative, not limiting. Various changes may be made without departing from the spirit and scope of the disclosure. Where methods and operations above indicate certain events, occurring in a certain order, those of ordinary skill in the art having the benefit of this disclosure would recognize, that the ordering of certain operations may be modified and such modifications are in accordance with the variations of the invention. Additionally, certain of the operations may be performed concurrently, in a parallel process, when possible, as well as performed sequentially as described above. The embodiments, have been particularly shown and described, but it will be understood that various changes in form and details may be made.

Some embodiments of the present disclosure has wide-ranging applications, addressing both utility-scale and community-level needs including, but not limited to, utility-scale wind or solar farms; remote communities and off-grid settlements; disaster relief and military applications; industrial and agricultural user; building integrated systems, and climate change adaptation applications.

For example, in utility-scale wind or solar farms applications, power producers may incorporate AWG systems as described herein into large renewable farms to monetize energy that would otherwise be wasted. For example, a wind farm operator implementing atmospheric water generation using curtailed renewable energy according to at least some embodiments of the present disclosure may produce tens of thousands of liters of water per day and sell it to local municipalities or for agricultural use. This provides an additional revenue stream and improves the overall economics of the renewable project. This is especially attractive in arid regions with good wind/solar resources but limited water (e.g., parts of the Middle East, North Africa, Southwest US, etc.). By advertising that their farm produces both clean energy and clean water, companies can also gain regulatory and public relation benefits. Government tenders for renewables might start favoring projects that have integrated water production for community benefit.

As another example, in remote communities and off-grid settlement applications, where remote villages or island communities rely on diesel generators (which are costly and polluting) and trucked-in water, some embodiments of the present disclosure provide for self-sufficient electricity and water. For example, by installing a renewable energy generation and AWG system that utilizes excess renewable energy as described herein, these communities can become both electricity and water self-sufficient. For example, a microgrid with solar panels and a wind turbine may power an AWG that provides drinking water for the village. During the rainy season or cooler months when renewable energy exceeds demand, extra water may be stored for the dry season. This reduces reliance on external water supplies and improves resilience. Humanitarian and development organizations could deploy such systems in areas facing drought or where wells have gone dry. The modular architecture of at least some embodiments of the present disclosure provides for scalability (e.g., a few kilowatts of solar with a small AWG for a hamlet, up to multi-MW and multiple AWGs for a large town, or the like).

As another example, in disaster relief and military applications, where infrastructure for power and water is often damaged in disaster-hit regions, mobile renewable AWG units can be rapidly deployed. This may include, for example, portable solar panels or a mobile wind turbine (e.g., inflatable wind turbines, foldable PV arrays, and/or or the like) attached to an AWG on a trailer (or other vehicle). These could provide emergency water supply without needing fuel logistics. Military forward operating bases or disaster response teams, which often are forced to use generators and struggle to get water trucked in, can utilize renewable AWG units which may significantly cut down logistical needs. The system's capability to use energy opportunistically as described herein allows for optimal use of renewable energy sources to produce water even under intermittent availability of sun or wind.

As another example, in industrial and agricultural applications where, for example, certain industries require demineralized or distilled water (e.g., for cooling processes, cleaning microelectronics, etc.), surplus power generated on-site may be used to produce ultra-pure water via AWG which in many examples is naturally distilled water. This is particularly applicable for factories or data centers in regions with expensive water. Further, agriculture in dry areas may benefit from implementation of techniques/systems described herein. For example, a solar-powered AWG system according to some embodiments may be leveraged to generate water to irrigate a small greenhouse or orchard in an otherwise barren area. This effectively turns sunlight into water for crops. While AWG water may be more expensive than river water in some examples, it may be viable in various contexts including for high-value agriculture in water-scarce zones (e.g., such as certain hydroponics, vineyards, etc.). In example, where certain minerals may not be present in AWG water, the absence of such minerals may be managed by adding nutrients as needed for irrigation.

As another example, in building integrated systems, commercial buildings or campuses with renewable installations (e.g., solar panels on a roof, wind turbine on-site) may integrate AWGs to supply part of their water demand (e.g., for cooling towers, toilets, or landscaping). If the building's solar produces excess at times (e.g., such as on weekends), the AWG may be activated to generate water which may be used immediately or stored. This water can offset municipal water use, saving costs especially where water tariffs are high. It may also provide redundancy in case of municipal supply issues. Further, corporations aiming for sustainability may implement this as part of water-positive or net-zero water goals.

In climate change adaptation applications (e.g., clean water access in climate change adaptation), as climate change affects rainfall patterns, some communities may find traditional water sources less reliable. However, they might have plentiful solar irradiance. A regional utility or government may deploy containerized solar-AWG units to areas facing water stress, ensuring a baseline water supply generated from atmospheric humidity. Even if each solar-AWG unit provides a few thousand liters a day, it may be sufficient to supply drinking water for hundreds of people. For example, when scaled, it is essentially creating water farms analogous to solar farms. Companies may operate these water farms and pipe or truck the water to nearby towns. Further, given that the input/feedstock is air and sun, it provides a desirable drought-resistant solution.

Some embodiments of the present disclosure may provide for new markets/opportunities at the intersection of the energy and water sectors. For example, some embodiments may facilitate collaboration/partnership between renewable energy companies and water utility companies to leverage techniques discussed herein. For example, one party may provide the hardware and operation for power-water conversion, while the other party may distribute the water. Furthermore, governments may incentivize such dual-use infrastructure with grants or carbon credits (e.g., water generated with zero emissions power has a much lower carbon footprint than many pumped water or desalination processes).

In some embodiments of the curtailed energy-based water generation framework of the present disclosure, the system may include a wind farm with integrated AWG such as, for example, a 50 MW wind farm in a coastal semi-arid region. Normally, at night the winds are strong and the local demand low, forcing curtailment of about 10% of the potential energy. In accordance with some embodiments of the present disclosure, each wind turbine in the farm may be fitted or paired with an AWG module (e.g., inside the base of the tower or in an adjacent container). When curtailment is signaled, the farm's supervisory controller may allocate power to each AWG proportional to the available surplus. In some embodiments, these AWGs may use refrigerated condensation (which may, for example, each be rated 1000 L/day at full power). By way of example, if the whole farm has 5 MW excess for a few hours, it may run 50 AWG modules at partial capacity, yielding thousands of liters of water by morning. In some embodiments, the collected water from all turbines may be piped to a central storage tank or a small water network that feeds a nearby village. In some embodiments, the materials for this implementation may include the wind turbine structure (which may already be designed for electrical generation) plus added plumbing for water. In some embodiments, using the height of the turbine towers may help condensation. For example, the air at hub height may be cooler at night and may enhance condensation. In some embodiments, the water may flow down via gravity inside the hollow tower to the base. In some embodiments, this implementation may include mechanical integration (e.g., the turbine's nacelle may house the AWG heat exchangers), leveraging the turbine's existing cooling systems for electronics to also cool water vapor.

In some embodiments of the curtailed energy-based water generation framework of the present disclosure, may include solar farm with thermal-storage desiccant AWG: In a desert solar farm of, for example, 20 MW, daytime curtailment may happen during spring when mild weather means low demand. This implementation may use a combination of photovoltaics (PV) and solar thermal collectors. Excess PV power may be used to run fans and a small heat pump if needed, while large flat-plate solar thermal collectors gather heat. A bank of thermal storage (e.g., phase change salts) may be charged with this heat. During nightfall, the hot storage may be used to regenerate desiccant beds which release water vapor. A portion of PV excess (e.g., stored in batteries) may then run a condenser cooling loop to turn that vapor to liquid water. This process may continue overnight, effectively using the prior day's “wasted” solar energy to produce water in the cooler, more humid night hours. By dawn, thousands of liters may be collected. Because this implementation relies more on heat, it extends the use of renewable energy beyond electricity into thermal domain. Materials used in this implementation may include, but not limited to, ceramic or polymer-based desiccant structures, insulated hot water/heat storage tanks, and/or a turbine-driven blower where a small wind turbine on site powers an air blower for the desiccant unit if there's night breeze (e.g., another cross-coupling).

In some embodiments of the curtailed energy-based water generation framework of the present disclosure, may include grid-tied water plant as curtailment sink: This implementation may be analogous or include a “water from air plant” built near a grid substation. It may not have its own renewable energy source, but may contracts with the grid operator/provider to consume power when there is excess in the region (e.g., during a sunny, cool day with low industrial demand). The plant may include multiple AWG modules (e.g., which may be containerized units each producing an amount of water (e.g., 5000 L/day for example)). The plant may also include a large water storage (e.g., tens of thousands of liters) and a dispatch pump configured to send (e.g. distribute) water into a municipal supply or fill trucks. Whenever the grid has a surplus (or even negative pricing events), the grid may transmit a signal to the plant and the plant may ramps to absorb (e.g., up to 5 MW of load in seconds in some examples) in response to receiving the signal. The plant using the AWG modules then produces water and stores the water. When surplus subsides, the AWGs powers down. The water may then be delivered to customers (e.g., a utility may use the water to supplement reservoir levels or for agricultural irrigation). Such a plant may act as a buffer converting otherwise lost electrical energy into a tangible commodity. The plant may run, for example, 200 days of the year when conditions allow, and remain on standby otherwise. In this implementation, a strong utility-grade interconnection may be needed, and the AWG hardware may be located in a controlled environment (e.g., warehouse or covered facility) for efficiency.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

1. A system, comprising:
at least one renewable energy source;
an atmospheric water generator (AWG) apparatus configured to extract water from ambient air, the AWG apparatus disposed at a predetermined elevation;
a controller operably couplable to at least one of the renewable energy source or the AWG apparatus, the controller configured to monitor a power output of the renewable energy source and detect when the power output exceeds a predetermined demand threshold; and
a power routing mechanism controllable by the controller, the power routing mechanism configured to divert at least a portion of the detected excess power output to the AWG apparatus.

2. The system of claim 1, wherein the AWG apparatus includes a vapor-compression refrigeration cycle having a compressor, a condenser, an expansion device, and an evaporator coil, the vapor-compression refrigeration cycle configured to condense water from air, and wherein the expansion device is a turbine expander configured to recover energy during refrigerant expansion to improve efficiency.

3. The system of claim 1, wherein the AWG apparatus includes a desiccant-based water absorption module having a hygroscopic material that absorbs moisture from air and a regeneration heater powered by the diverted excess energy to release the absorbed moisture as water vapor for condensation.

4. The system of claim 1, further comprising at least one of:
an energy storage subsystem, the energy storage subsystem including at least one of:
an electrical battery bank configured to store a surplus energy and supply the surplus energy to the AWG apparatus during at least a time period of no available excess power, or
a thermal storage unit configured to store a cooling or heating capacity using at least a portion the excess power, wherein the heating capacity includes at least one of a phase-change material or thermal fluid.

5. The system of claim 1, wherein the controller is further configured to receive a curtailment signal from an electrical grid or to sense a local overproduction of power, and adjust a power consumption of the AWG apparatus based on the received signal or sensed local overproduction.

6. The system of claim 1, wherein the renewable energy source includes at least one of a wind turbine or a wind farm.

7. The system of claim 6, wherein the wind turbine is configured to power the AWG apparatus at least in part via a mechanical coupling, the wind turbine configured to rotate such that it directly powers at least one of a compressor or an air circulation device of the AWG apparatus.

8. The system of claim 1, wherein the renewable energy source includes a solar photovoltaic (PV) array, and the system further includes a battery, the battery configured to be charged by excess PV during sunlight hours and to power at least a portion of the AWG apparatus during non-sunlight hours.

9. The system of claim 1, wherein the AWG apparatus comprises a plurality of AWG units and the controller is configured to incrementally activate or deactivate individual AWG units based on an amount of curtailed energy available.

10. The system of claim 1, wherein the AWG apparatus includes an air intake with dust filtration and condensing surfaces of the AWG are coated with a non-stick, corrosion-resistant coating to ensure reliable operation in outdoor environments with dust or salt content in the air above a predetermined threshold.

11. The system of claim 1, wherein water produced by the AWG apparatus is collected in a storage tank and is treated by a purification system (including at least one of UV sterilization, ozonation, or carbon filtration) to generate a potable water.

12. The system of claim 11, further comprising:
a distribution system configured to deliver the extracted water for end use, the distribution system including at least one of:
a pipeline connecting the storage tank to a municipal water network,
a tanker filling station to transport water off-site, or
a dispensing outlet for local consumption.

13. The system of claim 1, wherein the controller is further configured to provide ancillary grid services by modulating AWG apparatus power consumption in response to grid frequency or voltage fluctuations, thereby acting as a fast-response load that helps stabilize the grid while simultaneously producing water.

14. The system of claim 1, wherein the renewable energy source includes at least one of a wind energy source or a solar energy source.

15. A method of producing water using curtailed renewable energy, comprising:
generating an electrical energy using a renewable source;
monitoring an electrical power grid or local load to identify when a surplus of renewable energy is present that would otherwise be curtailed;
during times of identified surplus, automatically diverting electrical energy that exceeds immediate demand to an atmospheric water generation process, and using that energy to extract water from ambient air;
collecting the water produced and storing it for usage; and
during times when no surplus energy is available, reducing or halting the atmospheric water generation process to avoid drawing power needed by other loads.

16. The method of claim 15, further comprising:
storing at least a portion of the surplus energy; and
using at least a portion of the stored energy to run the atmospheric water generation.

17. The method of claim 15, wherein the atmospheric water generation process includes a vapor-compression cycle, the vapor-compression cycle including:
expanding a refrigerant through an expansion turbine to recover energy and improve efficiency during water condensation.

18. The method of claim 15, wherein the renewable source is curtailed according to grid directives and the method provides a water output in proportion to the curtailed energy, and wherein the water output is supplied to users.

19. A method, comprising:
identifying an excess renewable energy;
communicating at least a portion of the identified renewable energy to an atmospheric water generator (AWG) system, the AWG system disposed at least at a first elevation;
generating water via the AWG system;
storing at least a portion of the generated water at the first elevation;
communicating at least a portion of the stored water down a gravitational potential energy gradient to a second elevation lower than the first elevation; and
utilizing at least a portion of gravitational potential energy released by the communicated at least the portion of the water to perform work on a system.

20. The method of claim 19, wherein the system includes a turbine, and performing work includes causing the turbine to generate electrical energy.

21. A system, comprising:
an atmospheric water generator (AWG) system located at a first elevation, the AWG system configured to generate water from ambient air;
a water storage and distribution system configured to store at least a portion of the water generated by the AWG system, the water storage and distribution system located at a second elevation equal to or less than the first elevation; and
an energy generation system configured to receive at least a portion of the stored water from the water storage and distribution system and convert a potential energy of the received water into energy, the energy generation system disposed at a third elevation less than the first elevation and the second elevation.

22. The system of claim 21, further comprising:
an energy storage system configured to receive energy, store energy, and communicate at least a portion of the stored energy to the AWG system.

23. The system of claim 22, wherein the energy storage system includes at least one of:
a thermal storage system configured to store a cooling capacity or a heating capacity;
a battery bank configured to store a surplus energy and supply the stored surplus energy to the AWG system; or
a mechanical storage system configured to convert received energy into mechanical energy.

24. The system of claim 23, further comprising:
a renewable energy system configured to generate energy from a renewable source and communicate at least a portion of the generated energy to at least one of the energy storage system or the AWG system.

25. The system of claim 24, wherein the renewable source includes at least one of a wind turbine or a solar photovoltaic array.

26. The system of claim 24, further comprising:
a controller configured to:
detect a curtailment condition in which energy generated by the renewable energy system exceeds a demand of an electrical grid or a primary load; and
in response to detecting the curtailment condition, cause at least a portion of the generated energy to be communicated to the AWG system.

27. The system of claim 26, wherein the controller is further configured to:
cause distribution of energy from the renewable energy system to at least one of the AWG system or the energy storage system; and
cause ramp up or ramp down of the AWG system based on an amount of the energy available.

28. The system of claim 26, wherein the controller is further configured to:
detect at least one of an environmental condition or an operating condition associated with the AWG system; and
adjust at least one setpoint of the AWG system based on the detected at least one of the environmental condition or operating condition.

29. The system of claim 26, wherein the controller is further configured to:
monitor for a fault associated with at least one of the AWG system, the water storage and distribution system, or the energy generation system; and
perform a mitigation action in response to detecting or predicting the fault.

30. The system of claim 26, wherein the controller is further configured to:
modulate a power consumption of the AWG system in response to at least one of a grid frequency fluctuation or a voltage fluctuation.

31. The system of claim 26, wherein the controller is further configured to:
incrementally activate, ramp up, ramp down, or deactivate individual AWG units of the AWG system in response to changes in an energy output of the renewable energy system.

32. The system of claim 26, wherein the controller is further configured to:
monitor a level of water stored in the water storage and distribution system; and
in response to detecting that the level has reached a predetermined threshold, cause at least a portion of the stored water to be released to the energy generation system.

33. The system of claim 26, wherein the controller is further configured to:
coordinate routing of energy generated by the energy generation system to at least one of the AWG system, the energy storage system, or an electrical grid.

34. The system of claim 22, wherein the energy generation system is further configured to communicate the converted energy to at least one of the energy storage system, the AWG system, or another system.
